(19) United States
(12) Patent Application Publication
(10) Pub. No.: US 2024/0273564 A1
(43) Pub. Date: Aug. 15, 2024

(54) METHOD AND APPARATUS OF PROVIDING REWARDS TO TOKEN OWNER

(71) Applicant: Dunamu Inc., Seoul (KR)

(72) Inventors: Jihoon LIM, Seoul (KR); Yeasol KIM, Seoul (KR); Hyeok CHOI, Gyeonggi-do (KR)

(73) Assignee: Dunamu Inc., Seoul (KR)

(21) Appl. No.: 18/428,612

(22) Filed: Jan. 31, 2024

(30) Foreign Application Priority Data
Feb. 15, 2023 (KR) 10-2023-0020373
Feb. 20, 2023 (KR) 10-2023-0022428
Nov. 3, 2023 (KR) 10-2023-0150510

(51) Int. Cl. G06Q 30/0207; G06Q 30/0645; H04L 9/00

(52) U.S. Cl. CPC G06Q 30/0207; G06Q 30/0645; H04L 9/50

(57) ABSTRACT

The present disclosure provides a method of providing a reward to a token owner. The method may include executing a smart contract for providing a reward to an owner of a token corresponding to a share of real property, and the smart contract may include: an instruction to transmit a first subtoken and a second subtoken corresponding to the token to a first account; an instruction to provide a first reward for the second subtoken to the first account; an instruction to transmit the second subtoken to a second account in response to receiving rental data for the token between the first account and the second account; and an instruction to provide the first reward to the second account when the second subtoken has been transmitted to the second account.

### CROSS-REFERENCE TO RELATED APPLICATIONS

This application is based upon and claims the benefit of priority from Korean Patent Application No. 10-2023-0020373, filed on Feb. 15, 2023, Korean Patent Application No. 10-2023-0022428, filed on Feb. 20, 2023, and Korean Patent Application No. 10-2023-0150510, filed on Nov. 3, 2023, the entire contents of which are incorporated herein by reference.

### TECHNICAL FIELD

The present disclosure relates to a technique for providing a reward to a token owner.

### BACKGROUND

In a variety of modern industries, a digital asset based on a blockchain technology may be used. A digital asset, such as a token, may be traded on a blockchain network and used to exchange value between token owners. In addition to trading tokens, token owners may use various methods to increase value of tokens owned by them while owning the tokens.

### SUMMARY

At least some embodiments of the present disclosure provide a technique for providing a reward to an owner of a token corresponding to a share of specific real property.

At least some embodiments of the present disclosure provide a technique enabling the owner of the token to rent a subtoken to a different user.

At least some embodiments of the present disclosure provide a technique enabling a contributive action to be applied to a contribution degree of the owner of the token when a rentee of a subtoken conducts the contributive action of increasing value of the real property.

At least some embodiments of the present disclosure provide a technique enabling a subtoken to remain in a rented state even when ownership of the token is assigned with the subtoken rented.

At least some embodiments of the present disclosure provide a technique for providing a reward for rental of each of a plurality of subtokens according to different reward systems.

Technical aspects disclosed herein are not limited to the technical aspects mentioned above, and other technical aspects not mentioned will be clearly understood by those skilled in the art to which the present disclosure pertains from the following description.

A method according to an embodiment of the present disclosure may include executing, by a processor connected to a computer network including a blockchain network, a smart contract for providing a reward to an owner of a token corresponding to a share of real property, wherein the smart contract may include: an instruction to transmit a first subtoken and a second subtoken corresponding to the token to a first account; an instruction to provide a first reward for the second subtoken to the first account; an instruction to transmit the second subtoken to a second account in response to receiving rental data for the token between the first account and the second account; and an instruction to provide the first reward to the second account when the second subtoken has been transmitted to the second account.

According to an embodiment, the smart contract may further include an instruction to provide a basic reward for the first subtoken corresponding to the second subtoken to the first account when the second subtoken has been transmitted to the second account.

According to an embodiment, the first reward may be provided to an account that completes proving a first qualification proving residence within a predetermined distance from the real property.

According to an embodiment, the smart contract may further include: an instruction to provide a second reward for the second subtoken to the first account; and an instruction to provide the second reward to the second account when the second subtoken has been transmitted to the second account.

According to an embodiment, the second reward may be provided to an account that completes a second qualification proving residence outside a predetermined distance from the real property.

According to an embodiment, the token may correspond to a third subtoken, and the smart contract may further include: an instruction to provide at least one of the first reward or a second reward to the second account; an instruction to transmit the third subtoken to the second account in response to receiving rental data for the third subtoken between the first account and the second account; and an instruction to provide the second reward to the second account when the third subtoken is transmitted to the second account.

According to an embodiment, the instruction to transmit the second subtoken to the second account may include an instruction to store the rental data including a number of second subtokens to be rented, a rental period, a wallet address of the first account, and a wallet address of the second account in the blockchain network in response to receiving the rental data.

According to an embodiment, the smart contract may further include an instruction to transmit the second subtoken transmitted to the second account to the first account when the rental period expires.

According to an embodiment, the smart contract may further include: an instruction to transmit the first subtoken corresponding to the second subtoken to a third account when the first account assigns the token corresponding to the second subtoken rented to the second account to the third account; and an instruction to update the rental data for the token indicating a wallet address of the first account to indicate a wallet address of the third account.

According to an embodiment, the smart contract may further include an instruction to receive an issued token number from a management terminal corresponding to a management account and to transmit as many first subtokens and second subtokens as the issued token number to the management account.

According to an embodiment, the smart contract may further include an instruction to receive a wallet address of the first account that purchases the token and a purchasing token quantity of the first account from a management terminal corresponding to a management account and to transmit as many first subtokens and second subtokens as the purchasing token quantity to the first account.

According to an embodiment, the smart contract may further include an instruction to provide a basic reward for the first subtoken to the first account every first period, and the instruction to provide the basic reward may include an instruction to transmit as many tokens as a token number determined according to a ratio of a number of tokens owned by the first account to a total number of issued tokens among a number of additionally issued tokens corresponding to a profit in the first period determined based on at least one of a profit from using the real property or a profit margin from selling the real property.

According to an embodiment, the smart contract may further include an instruction to provide an additional reward for the first subtoken to the first account every second period, and the instruction to provide the additional reward may includes an instruction to determine a number of additionally issued tokens corresponding to the second period, based on total real property value contribution degree data generated based on pieces of real property value contribution degree data of a plurality of accounts owning the tokens.

According to an embodiment, the instruction to provide the additional reward may include an instruction to determine the number of additionally issued tokens, based on a contribution degree excess when a total real property value contribution degree included in the total real property value contribution degree data exceeds a threshold contribution degree.

According to an embodiment, the instruction to provide the additional reward may include an instruction to update real property value contribution degree data of the first account by adding a contribution degree included in real property value contribution degree data of the second account to a contribution degree included in the real property value contribution degree data of the first account.

According to an embodiment, the instruction to provide the additional reward may include: an instruction to calculate a real property value contribution ratio of the first account, based on the updated real property value contribution degree data of the first account and the total real property value contribution degree data; and an instruction to transmit a predetermined number of tokens among the number of additionally issued tokens to the first account, based on the calculated real property value contribution ratio of the first account.

According to an embodiment, the smart contract may further include an instruction to initialize real property value contribution degree data of each of a plurality of accounts owning the token after completing an operation of providing an additional reward to the first account.

An electronic device according to another embodiment may include: a communication interface configured to enable communication with a network; a processor configured to execute a computer program including at least one instruction; and a memory configured to load the computer program, wherein the computer program may include: an instruction to transmit a first subtoken and a second subtoken corresponding to a token to a first account; an instruction to provide a first reward for the second subtoken to the first account; an instruction to transmit the second subtoken to a second account in response to receiving rental data for the token between the first account and the second account; and an instruction to provide the first reward to the second account when the second subtoken has been transmitted to the second account.

According to an embodiment, a processor included in a user terminal connected to a computer network including a blockchain network may: transmit a number of issued tokens determined based on a user input to an address of a smart contract; receive a wallet address of a first account and a purchasing token quantity from a first terminal corresponding to the first account that is a token purchaser; and transmit the wallet address of the first account and the purchasing token quantity to the address of the smart contract.

According to an embodiment, a processor included in a user terminal connected to a computer network including a blockchain network may: receive a user input for a purchasing token quantity and transmit the purchasing token quantity and a wallet address of a first account to a management terminal corresponding to a management account; receive a user input to confirm a contribution degree to receive real property value contribution degree data of the first account from the blockchain network; receive a user input to modify a contribution degree and transmit a request to modify the real property value contribution degree data of the first account to the blockchain network; receive a user input to confirm a reward and request data related to a basic reward and an additional reward scheduled to be provided to the first account from the blockchain network; receive a user input to confirm a reward and output a first reward provided to the first account on a screen; and receive a user input to confirm a rental to output rental data on the screen.

According to an embodiment, a processor included in a user terminal connected to a computer network including a blockchain network may: transmit a wallet address of a second account to a first terminal of a firs account that owns a token; receive a user input to confirm a contribution degree and request real property value contribution degree data of the second account from the block chain network; and receive a user input to confirm a reward and output a first reward provided to the second account on a screen.

According to an embodiment, a method of providing a reward to an owner of a token corresponding to a share of real property by a processor connected to a computer network including a blockchain network may include: providing a reward to a first account that owns the token, based on real property value contribution degree data of the first account; providing an occupation reward to the first account that occupies the token; transmitting the token to the second account in response to receiving rental data for the token between the first account and the second account; providing a reward to the first account, based on real property value contribution degree data of the second account that receives the token; and providing the occupation reward to the second account that occupies the token.

### BRIEF DESCRIPTION OF DRAWINGS

The accompanying drawings, which are incorporated in and constitute a part of the specification, illustrate embodiments of the present disclosure.

FIG. 1 illustrates an environment to which devices according to an embodiment of the present disclosure can be applied.

FIG. 2 illustrates a node for configuring any one of devices according to an embodiment of the present disclosure.

FIG. 3 is a flowchart illustrating a method of renting a token according to an embodiment of the present disclosure.

FIG. 4A to FIG. 4D illustrate screens of a user terminal of a token owner according to various embodiments of the present disclosure.

FIG. 5 is a flowchart illustrating a method of withdrawing a token upon expiration of a rental period according to an embodiment of the present disclosure.

FIG. 6 is a flowchart illustrating a method of renting a token when the token is traded according to various embodiments of the present disclosure.

FIG. 7 illustrates a method of providing a basic reward and an additional reward according to various embodiments of the present disclosure.

FIG. 8A and FIG. 8B illustrate screens of a user terminal connected to a management account according to various embodiments of the present disclosure.

FIG. 9A and FIG. 9B illustrate screens of a user terminal connected to a second account renting a token from a first account according to various embodiments of the present disclosure.

FIG. 10 is a flowchart illustrating an operation of a terminal of a token owner according to various embodiments of the present disclosure.

### DETAILED DESCRIPTION

Various embodiments disclosed herein are illustrated for clearly describing the technical idea of the present disclosure, and are not intended to limit the present disclosure to specific embodiments. The technical idea of the present disclosure includes various modifications, equivalents, and alternatives of each embodiment disclosed herein and a selective combination from all or part of the embodiments. Further, the scope of the technical idea of the present disclosure is not limited to various embodiments to be illustrated below or a specific description thereof.

Unless otherwise defined, all terms including technical and scientific terms used herein may have the same meaning as commonly understood by a person having ordinary knowledge in the art to which the disclosure belongs.

The expressions “include,” “may include,” “provided with,” “may be provided with,” “have,” and “may have” used herein refer to the existence of a corresponding feature (e.g., a function, an operation, or a constituent element), and do not exclude the existence of one or more additional features. That is, these expressions should be understood as open-ended terms connoting the possibility of inclusion of other embodiments.

A singular expression used herein may include meanings of a plurality unless otherwise mentioned, and the same is applied to a singular expression recited in the claims.

Unless otherwise defined, the expressions “a first” and “a second” or “the first” and “the second” used herein are used to distinguish one component from another component in referring to a plurality of components of the same kind, and are not intended to limit the order or importance of components.

The expression “A, B, and C,” “A, B, or C,” “at least one A, B, and C ,” or “at least one of A, B, or C” used herein may refer to respective listed items or all possible combinations of the listed items. For example, the expression “at least one of A or B” may refer to all of (1) at least one A, (2) at least one B, or (3) at least one A and at least one B.

The expression “based on” used herein is used to describe one or more factors that influence a decision, an action of judgment, or an operation described in a phrase or sentence including the relevant expression, and does not exclude an additional factor influencing the decision, the action of judgment, or the operation.

It will be understood that when a certain component (e.g., a first component) is described as being “coupled to” or “connected to” another component (e.g., a second component), the certain component may be coupled or connected directly to the other component, or the certain component may be coupled or connected to the other component via a new intervening component (e.g., a third component).

The expression “configured to” used herein may have a meaning of “set to,” “having the capacity to,” “changed to,” “made to,” or “capable of” according to context. This expression is not limited to a meaning of “specifically designed in hardware.” For example, a processor configured to perform a specific operation may refer to a generic-purpose processor capable of performing the specific operation by executing software, or may refer to a special-purpose processor structured through programming to perform the specific operation.

The term “unit” used herein may refer to software or a hardware component, such as a field-programmable gate array (FPGA) and an application-specific integrated circuit (ASIC). However, a “unit” is not limited to software and hardware. A “unit” may be configured to be stored in an addressable storage medium, or may be configured to execute one or more processors. In an embodiment, a “unit” may include components, such as software components, object-oriented software components, class components, and task components, a processor, a function, an attribute, a procedure, a subroutine, a segment of a program code, a driver, firmware, a micro-code, a circuit, data, a database, a data structure, a table, an array, and a variable.

The term “smart contract” used herein may be a program or an application operating on a virtual machine executed by two or more nodes included in a blockchain network. A smart contract may be written to comply with a particular regulation (or protocol). For example, a smart contract may be written to include one or more functions corresponding to respective protocols with reference to ERC-20, ERC-721, or ERC-1155. However, various types of smart contracts may be written by including other functions not be included in the illustrated protocols.

The term “blockchain network” used herein may include two or more nodes that manage a blockchain. A block may refer to a specific data type. A blockchain may refer to a data structure in which one or more blocks are connected in a chain form. The one or more blocks included in the blockchain may be independently stored respectively in a plurality of nodes included in a blockchain network, or may be stored in a distributed manner across a plurality of node. Each of the one or more blocks may include a block hash value, a block header, or a block body. The block hash value is unique information for identifying the block, and may be, for example, a character string expressed in 256 bits. The block header may include, for example, at least one of version information about software or a protocol, a hash value of a previous block according to an order in which the blocks are connected in the blockchain, a Merkle root, time information indicating a time at which the block is generated, bits indicating difficulty of calculation, or a nonce that is a value needed in a mining process for adding a new block to the block chain. The block body may include at least one transaction. The transaction is a set of pieces of data having a specific data structure, and may be a unit of information stored in the block body. The transaction may include information about generation or trading of a token.

Each of at least one node included in the blockchain network may be referred to as a “participant” in the blockchain network. At least one node included in the blockchain network may be operated by a hierarchical structure. The hierarchical structure may include, for example, at least one of a data layer that defines a structure of data handled by the blockchain network and manages the data, a consensus layer that verifies validity of a block, performs mining of generating a block, and is in charge of processing a fee provided to a miner in a mining process, a common layer that implements or manages a P2P network protocol, a hash function, a digital signature, encoding, and a common storage, or an application layer that generates or processes various applications.

At least one node included in the blockchain network may share or store a transaction recorded on the blockchain. In addition, at least one node included in the blockchain network may verify a transaction transmitted to the blockchain network through a consensus algorithm of the blockchain, and may perform a function of recording the verified transaction in a block on the blockchain when verification is completed. There is no restriction on the type of a consensus algorithm performed by the blockchain network, and any type of consensus algorithm that is adoptable and modifiable by a person skilled in the art may be performed. For example, the consensus algorithm may include at least one of a Proof of Work (PoW) algorithm, a Proof of Stake (PoS) algorithm, a Delegated Proof of Stage (DPoS) algorithm, a Practical Byzantine Fault Tolerance (PBFT) algorithm, a Delegated Byzantine Fault Tolerance (DBFT) algorithm, a Redundant Byzantine Fault Tolerance (RBFT) algorithm, a Sieve algorithm, a Tendermint algorithm, a Paxos algorithm, a Raft algorithm, a Proof of Authority (PoA) algorithm, or a Proof of Elapsed Time (PoET) algorithm, or an application of the foregoing consensus algorithms.

Each of at least one node included in the blockchain network may store a smart contract. Accordingly, at least one node included in the blockchain network may share the same smart contract. The smart contract may be recorded in a block on the blockchain managed by the blockchain network. The smart contract is, for example, a specification or script written in a programming language, such as Solidity, and may be a program or application that runs on a virtual machine executed by at least one node included in the blockchain network. The smart contract may be written to execute a specific operation when a specific condition is satisfied. The specific condition may be, for example, a condition of inputting a specific type of token or inputting a specific type of file. The specific operation may be, for example, an operation of transmitting a specific type of token to a random node in the blockchain network.

The term “token” used herein may refer to a digital asset or a unit of value. A token may be recorded on a blockchain network, and may exist in an electronic form. A blockchain-based platform may have an economic model that issues an own token and uses the token within an ecosystem to provide a service fee, a reward, a discount, and the like. The token may support and regulate various economic activities within the ecosystem. Further, the blockchain token may be used as a method for proving a specific asset or ownership. For example, a physical asset, such as real property or an artwork, may be expressed as a blockchain token to prove and transmit ownership. The token may include a security token. The security token refers to digitized securities (e.g., a stock, a bond, and real property) under the Capital Markets Act. For example, token owners may receive a portion of profits made by a token issuer as a dividend or have a portion of management rights of the issuer through security tokens. A smart contract standard for the security token may be an Ethereum Request for Comment (ERC) standard adoptable by a person skilled in the art and an interface form modifiable by a person skilled in the art. For example, a smart contract interface for the security token may be ERC 1400, ERC1594, ERC1410, ERC1643, ERC1644, or ERC3643.

The term “subtoken” used herein may be for configuring a specific rule and restriction for ownership and trading of a token (or a subtoken corresponding to a token). Information about at least one subtoken corresponding to one token may be recorded in a smart contract and stored in a blockchain, or may be recorded only in a memory of a user terminal or a server without being stored in the blockchain, or only some of the information about the subtoken may be stored in the blockchain.

In an embodiment, when the information about the subtoken is stored in the blockchain, the information about the subtoken may be stored in various data structure formats. For example, when the smart contract interface is the ERC1400 standard, the information about the subtoken may be recorded using an ERC1400 partition. Specifically, an ERC 1400 security token may be divided into a plurality of partitions. A partition may be defined by an institution that issues and manages the security token, a platform, or the smart contract. For example, configuring a plurality of partitions in one token makes it possible to distinguish categories of users or to separate kinds or types of assets. For example, partition A corresponding to a token owner category and partition B corresponding to a token rentee category may be configured in one token.

The term “digital asset” used herein may refer to any information that is expressed in a binary form and is available as an asset. A digital asset may be, for example, text, a 2D image, a 3D image, a video, or a polygon graphic. More specifically, the digital asset may be text, a 2D image, a 3D image, a video, or a polygon graphic of clothing, a bag, an accessory, furniture, a vehicle, a building, real estate, a game item, or a digital card.

The term “platform” used herein may refer to an environment in which services of the same or similar purposes are integrated and managed to be used for users. This environment may be provided for users by software (e.g., a computer program or an application) operating on hardware (e.g., a server, a client, an input unit 250, an output device, or a network device). Although there may be differences in detailed meaning, a platform may be comprehensively interchangeable with “software,” “application,” or “solution.”

The term “digital asset wallet” used herein may be a tool for safely storing and managing a personal digital asset in an electronic form. A digital asset wallet may store and manage information related to a cryptocurrency or a digital asset. Digital asset wallets may be classified into a hot wallet and a cold wallet. The hot wallet is a wallet connected to the Internet, which allows access to a cryptocurrency in an online environment. Generally, the hot wallet may be provided as a software wallet or an online service. The hot wallet may provide convenient and quick access to transmit a cryptocurrency, and may process a transaction quickly. The cold wallet may be a wallet that stores a private key in an offline environment in which the Internet is connected. Generally, the cold wallet may be provided as a hardware wallet or a paper wallet. The cold wallet may securely protect the private key and store the private key offline, thus providing a high level of security against hacking or attacks from malicious software.

The expression “transmitting a transaction to a blockchain” used herein may include (1) uploading specific data to the blockchain, (2) modifying or deleting data already uploaded to the blockchain, or (3) executing a smart contract distributed to the blockchain.

The term “transaction” used herein is a logical unit of an operation performed on a blockchain. A transaction used herein may include a transaction recorded on a blockchain and/or a transaction not recorded on the blockchain. For example, a transaction of an Ethereum blockchain may include (1) a transaction recorded on the blockchain including a transaction hash value and (2) a message (internal transaction) generated when the transaction is executed in an Ethereum virtual machine (EVM).

Hereinafter, various embodiments disclosed herein will be described with reference to the accompanying drawings. In the accompanying drawings and description of the drawings, the same or substantially equivalent components may be given the same reference numerals. Although a redundant description of the same or corresponding components may be omitted in the following description of various embodiments, such components are not intended to be excluded in the embodiments.

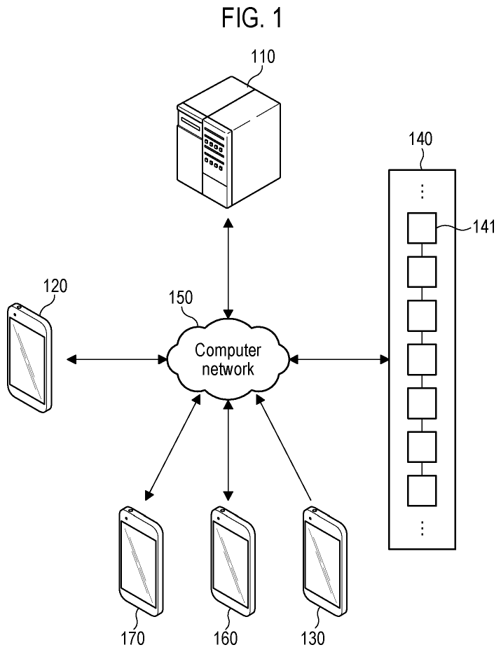

FIG. 1 illustrates an environment to which devices according to an embodiment of the present disclosure can be applied. The environment may include a server 110, a first user terminal 120, a second user terminal 130, a third user terminal 160, a management terminal 170, a blockchain network 140, and/or a computer network 150. The blockchain network 140 may include two or more nodes 141. The server 110, the first user terminal 120, the second user terminal 130, and each node 141 of the blockchain network 140 may communicate with each other through the computer network 150. The computer network 150 refers to a digital electric communication network, which connects various distributed devices through a predetermined communication network. The computer network 150 may be configured as any type of wired or wireless network, such as a local area network (LAN), a wide area network (WAN), a mobile radio communication network, or a wireless broadband Internet (WiBro). Although FIG. 1 shows an environment in which the server 110 communicates with three user terminals 120, 130, and 160 and seven nodes 141 through the computer network 150, which is merely an example, the number of user terminals and the number of nodes may change.

The server 110 may be a server that configures a token trading platform. The server 110 may perform various processes related to token trading. For example, the server 110 may manage an address of each digital asset wallet in which tokens of users are stored. In the present disclosure, an account may be a unique string for proving a user's identity or identifying a user in the token trading platform. For example, an account may include a letter, a number, a symbol, and the like. Users may trade tokens by accessing the token trading platform with unique accounts given to the users. When the users are given the accounts on the token trading platform, the users may be issued with one or more digital asset wallets (or wallets) per account for token trading. For example, a token included in a digital asset wallet corresponding to one account may be transmitted to a digital asset wallet corresponding to another account through the token trading platform. In an embodiment, the server 110 may store and/or manage token ownership information. In another embodiment, the server 110 may transmit a transaction of storing and/or managing token ownership information to the blockchain network 140. In this case, for example, the first user terminal 120 may transmit the transaction of storing and/or managing the ownership information to the server 110, and the server 110 may transmit the received transaction to the blockchain network 140. In another example, the first user terminal 120 may directly transmit the transaction of storing and/or managing the ownership information to the blockchain network 140 without going through the server 110. In addition to the foregoing examples, the server 110 may perform various operations (e.g., communication between users) generally required in the platform. Further, the server 110 may participate in the issuance and transaction of a token by interacting with at least one node 141 included in the blockchain network 140.

The server 110 may be configured as one or more computing devices. For example, all functions of the server 110 may be configured in a single computing device. In another example, a first function of the server 110 may be configured in a first computing device, and a second function may be implemented in a second computing device. The computing devices may be a desktop computer, a laptop computer, an application server, a proxy server, a cloud server, or the like, without being limited thereto, and may include various types of devices having a computing function.

The first to third user terminals 120, 130, and 160 may be terminals of users using the token trading platform. Each user may use various functions provided by the token trading platform through the first to third user terminals 120, 130, and 160. For example, each user may request issuance of a token, may identify a dashboard visually displaying a token issuance status, or may communicate with another user through the first to third user terminals 120, 130, and 160. For each user to use the token trading platform, a dedicated application may be installed in the first to third user terminals 120, 130, and 160. Alternatively, the first to third user terminals 120, 130, and 160 may use the token trading platform by accessing a web browser provided by the server 110. Each of the first to third user terminals 120, 130, and 160 may be, for example, any one device among a desktop computer, a workstation, a laptop computer, a tablet computer, an audio player, a wearable device, or a smartphone, without being limited to these examples, and may include various types of computing devices having a computing function.

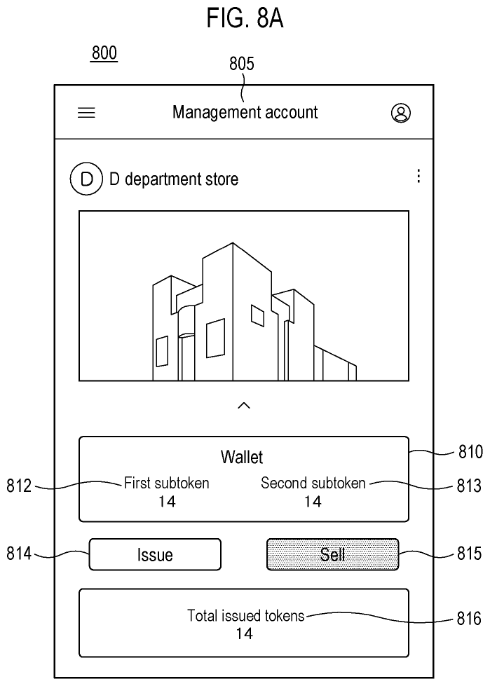

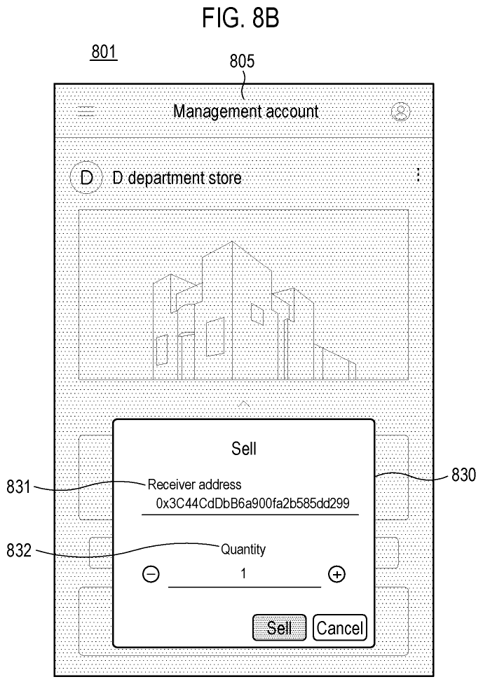

The first user terminal 120 may be a terminal of a user corresponding to one account (hereinafter, a “first account”). The user of the first account may access the token trading platform with the first account through the first user terminal 120. The user of the first account may perform an operation, such as token trading or rental, related to the first account through the first user terminal 120. The first account may be an account that purchases a certain amount of tokens from a management account 805 of the token trading platform. The management account 805 (e.g., a management account 805 of FIG. 8A and FIG. 8B) may be an account that issues a token to purchase real property and sells the issued token to raise a real property purchasing fund from the sales proceeds. For example, the management account 805 may be at least one of an asset manager account, a personal account that purchases real property, or a corporate account. The management account 805 is an account of a management entity of the token trading platform, and may control the server 110 to perform various processes related to token trading. Two or more accounts may separately perform roles of the management account 805. That is, operations performed by the management account 805 may be performed by the two or more accounts. The roles of the management account 805 may be performed separately by a securities company account, an issuer account management agency account, and/or an over-the-counter trading broker account. For example, a process related to account management may be performed by the issuer account management agency account, and a process related to asset trading over the counter may be performed by the over-the-counter trading broker account.

The management terminal 170 may be a terminal corresponding to the management account 805. The management terminal 170 may be a user terminal corresponding to the management account 805. The management terminal 170 may be one of user terminals. A user (e.g., a management entity) of the management account 805 may access the token trading platform with the management account through the management terminal 170. For example, the management account 805 may determine a total token issuance amount corresponding to a real property share. The second user terminal 130 may be a terminal of a user corresponding to an account (hereinafter, a “second account”) that is different from the first account. The user of the second account may access the token trading platform with the second account through the second user terminal 130. The user of the second account may perform an operation, such as token trading or rental, related to the second account through the second user terminal 130. The second account may be an account that rents a subtoken of one token from the first account. The third user terminal 160 may be a terminal of a user corresponding to still another account (hereinafter, a “third account”). The user of the third account may access the token trading platform with the third account through the third user terminal 160. The third account may be an account that purchases one or more tokens from the first account.

One node 141 included in the blockchain network 140 may refer to a device of a participant participating in the blockchain network 140. The node 141 may be an element forming the blockchain network 140. The node 141 may perform calculation to maintain a blockchain of the blockchain network 140. For example, one random node of the blockchain network 140 may generate a new block of the blockchain, and the new block may be shared among other nodes of the blockchain network and be connected to a next block of the blockchain through a distributed consensus process. That is, the node 141 may perform an operation of generating, verifying, or propagating a transaction and a block in which the transaction is recorded. The node 141 may be a full node, a light node, a master node, a mining node, a random node, a baking node, or a super node depending on an operation performed by the node. The node 141 may issue a token by interacting with the server 110. Issuing a token may refer to a process in which an issuer generates a specific amount of tokens by using a smart contract and stores the generated tokens in a wallet thereof.

The node 141 may be configured as a computing device. For example, the computing device may be a desktop computer, a laptop computer, or the like, without being limited thereto, and may include various types of devices having a computing function.

The server 110, the node 141, and the user terminals 120 and 130 may represent functionally distinct elements. That is, two or more components may be configured in an integrated form in an actual physical environment. For example, the server 110 and the node 141 included in the blockchain network 140 may be configured in a form of different logics within the same computing device. That is, for example, the server 110 may be configured to operate as the node 141 of the blockchain network 140.

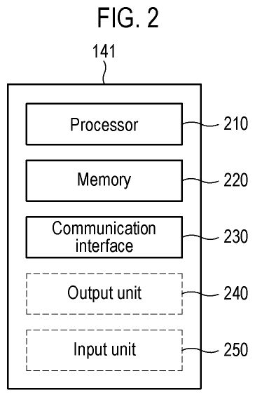

FIG. 2 illustrates a node 141 for configuring any one of devices according to an embodiment of the present disclosure. In the present disclosure, the node 141 may be expressed as an electronic device, and the node 141 may be interchangeably referred to as the electronic device. The node 141 may include one or more processors 210 or one or more memories 220. In an embodiment, some components may be deleted from the node 141, or other components (e.g., an output unit 240) may be added to node 141. Additionally or alternatively, some components may be configured in an integrated manner, or may be configured as a single entity or a plurality of entities. In the present disclosure, the one or more processors 210 may be referred to as a processor 210. The term “processor” 210 may refer to a set of one or more processors unless clearly indicated otherwise in the context. In the present disclosure, the one or more memories 220 may be referred to as a memory 220. The term “memory” 220 may refer to a set of one or more memories unless clearly indicated otherwise in the context.

At least some components in the node 141 may be connected to each other through a bus, a general-purpose input/output (GPIO), a serial peripheral interface (SPI), or a mobile industry processor interface (MIPI) to exchange data or signals.

The processor 210 may control each component of the node 141, or may perform calculation or data processing related to communication. Specifically, the processor 210 may control at least one component of the node 141 connected to the processor 210 by driving software (e.g., a command or a program) received from a different component. For example, the processor 210 may load a command or data into the memory 220, may process a command or data stored in the memory 220, and may store data resulting from processing in the memory 220. Further, the processor 210 may be operatively connected to components of the node 141 to perform an operation, such as various types of calculations, processing, and data generation or processing related to the present disclosure.

The memory 220 may store various pieces of data. The data stored in the memory 220 may be data obtained, processed, or used by at least one component of the node 141, and may include software (e.g., a command or a program). For example, the memory 220 may store commands for an operation as a computer program. The computer program may include one or more commands that, when loaded into the memory 220, cause the processor 210 to perform an operation according to various embodiments of the present disclosure. That is, the processor 210 may perform operations according to various embodiments of the present disclosure by executing the one or more commands. The memory 220 may include a volatile or nonvolatile memory. In an embodiment, a command or a program may be software stored in the memory 220, and may include an operating system for controlling a resource of the node 141, an application, or middleware providing various functions to the application so that the application may utilize resources of the node 141.

In an embodiment, the node 141 may further include a communication interface 230. The communication interface 230 may establish a wired or wireless communication channel with an external device (e.g., a server 110 or a user terminal 120), and may transmit and receive various pieces of data to and from the external device. In an embodiment, the communication interface 230 may include at least one port for connecting with the external device via a wired cable to communicate with the external device by wire. In this case, the communication interface 230 may communicate with the external device connected by wire through the at least one port. In an embodiment, the communication interface 230 may be configured to include a cellular communication module to connect to a cellular network (e.g., 3G, LTE, 5G, WiBro, or WiMax). In an embodiment, the communication interface 230 may include a short-range communication module to transmit and receive data to and from the external device by using short-range communication (e.g., Wi-Fi, Bluetooth, Bluetooth Low Energy (BLE), or UWB). In an embodiment, the communication interface 230 may include a contactless communication module for contactless communication. The contactless communication may include at least one contactless short-range communication technology, for example, NFC, radio-frequency identification (RFID) communication, or magnetic secure transmission (MST) communication. In addition to the foregoing various examples, the node 141 may be configured in various known methods for communicating with the external device, and the scope of the present disclosure is not limited by the foregoing examples.

In an embodiment, the node 141 may further include an output unit 240. The output unit 240 may display various screens, based on control of the processor 210. For example, the output unit 240 may display a dashboard visually displaying a token ownership status of platform users, based on control of the processor 210. To display the dashboard on the output unit 240, for example, a web browser or a dedicated application may be installed in the node 141. In an embodiment, the web browser or the dedicated application may be configured to provide a user with a token issuance request function or a function of communicating with a different user through a user interface. The output unit 240 is a component capable of interacting with the user, and may display various screens, based on control of the processor 210 and receive a user input from the user. The output unit 240 may be configured in a form of a touch sensor panel (TSP) capable of recognizing contact with or proximity of various external objects (e.g., a finger and a stylus). The touch sensor panel may have various structures and types, and the present disclosure may be applied regardless of the structure and type of the touch sensor panel. The output unit 240 may be omitted from the node 141 depending on embodiments.

In an embodiment, the node 141 may further include an input unit 250 (e.g., a mouse or a keyboard). The input unit 250 may receive data to be used in a component (e.g., the processor 210) of the node 141 from the outside (e.g., a user) of the node 141. The input unit 250 may be omitted from the node 141 depending on embodiments.

In an embodiment, each of the user terminals 120, 130, 160, and 170 and the server 110 may include one or more processors and/or one or more memories. The user terminals 120, 130, 160, and 170 and the server 110 may further include a communication interface, an output unit, and/or an input unit. The foregoing configuration of the user terminals 120, 130, 160, and 170 and the server 110 is merely an example, and the present disclosure is not limited thereto.

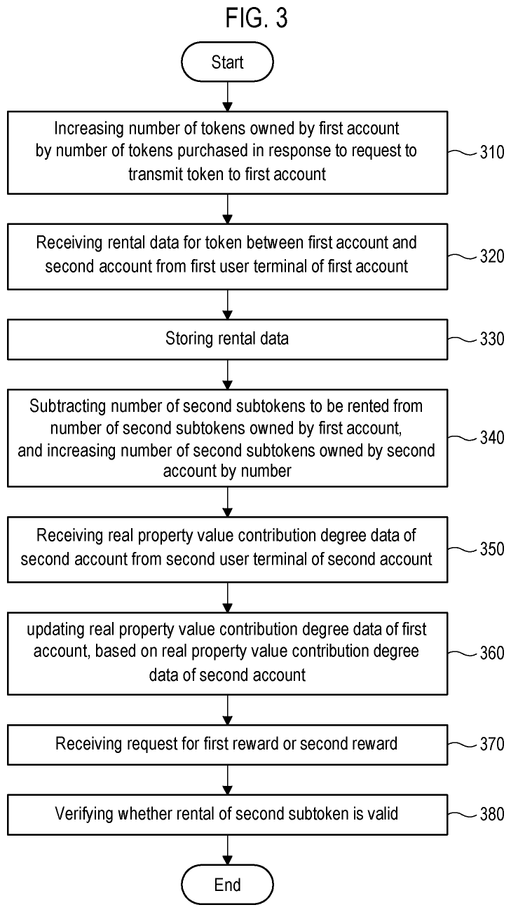

FIG. 3 is a flowchart illustrating a method of renting a token according to an embodiment of the present disclosure. As described above, a first account may be an account that purchases a certain amount of tokens from a management account and owns the tokens. A second account may be an account that rents a subtoken corresponding to one token from the first account.

In the present disclosure, each account communicating with a smart contract may mean that a user terminal connected with the account communicates with the smart contract through a server 110. In this process, the server 110 may communicate with at least one 141 of two or more nodes.

In another embodiment, each account communicating with a smart contract may mean that a user terminal communicates directly with the smart contract without involvement of the server 110, in which case the user terminal may communicate with at least one 141 of two or more nodes.

In addition, each account communicating with a different account may mean that a user terminal connected with the account communicates with a user terminal connected with the different account through the server 110 or directly without involvement of the server 110.

An operation performed by a smart contract may be performed by a processor 210 of the at least one node 141 executing an instruction included in the smart contract. A processor mentioned below may be the processor 210 included in the node 141. The instruction described in the present disclosure may be configured as various methods that can be modified by those skilled in the art, and a method for operating the instruction disclosed herein does not limit a method for configuring the instruction included in the smart contract. According to an embodiment, the instruction described in the present disclosure may be configured in a form of being included in the smart contract, or may be configured in a form in which only part of the instruction is included in the smart contract and other part is not be included in the smart contract. Accordingly, in the present disclosure, “executing an instruction” may include both a case in which the processor 210 includes an instruction included in a smart contract and a case in which the processor 210 includes an instruction not included in a smart contract.

The first account according to an embodiment may purchase a token from the management account. In the present disclosure, “purchasing a token” may include an operation in which a user terminal of the first account pays the price of the token to an owner of the management account through the server 110 or directly without involvement of the server 110. In another embodiment, purchasing a token may include an operation of receiving information that the price of the token has been paid from an external server.

When the first account purchases a token, a management terminal 170 corresponding to the management account that has sold the token may request transmission of the token to the first account from the processor 210 of the node 141 through the server or directly without involvement of the server 110. The processor 210 may transmit a first subtoken and a second subtoken corresponding to the token to the first account. In the present disclosure, “an operation of transmitting a token to a specific account” may refer to an operation of the processor 210 of the node 141 transmitting a token of one account to another account in response to a token transmission request. In an example of implementing the operation, the processor 210 may execute an instruction to increase the number of tokens owned by a specific account in response to a request to transmit a token from one account to the specific account. In this case, the processor 210 may execute an instruction to reduce a token ownership amount of the one account by an increased token ownership amount of the specific account. Increasing the token ownership amount of the specific account (receiving account) by the reduced token ownership amount of the one account may generate an effect as if some of the tokens owned by the one account are transmitted to the specific account. For convenience of explanation, the following description is made assuming that transmission of a token or a subtoken is performed according to the foregoing method. The processor 210 may execute an instruction to transmit the first subtoken and the second subtoken corresponding to the token to the first account in response to a request to transmit the token to the first account from the management terminal 170. In an embodiment, the processor 210 may increase the number of tokens owned by the first account by the number of tokens purchased by the first account from the management account in response to the request to transmit the token to the first account (310). Specifically, the processor 210 may execute an instruction to increase the number of tokens owned by the first account by the number of tokens purchased by the first account from the management account. Further, the processor 210 may reduce the number of tokens owned by the management account by the number of tokens purchased by the first account from the management account. Specifically, the processor 210 may execute an instruction to reduce the number of tokens owned by the management account by the number of tokens purchased by the first account from the management account. For example, when the request to transmit the token includes transmission of two tokens from the management account to the first account, the processor 210 may execute an instruction to subtract two tokens from the number of tokens owned by the management account and to increase the number of tokens owned by the first account by two tokens.

In an embodiment, the number of the at least one first subtoken and the number of the at least one second subtoken may be the same as the number of tokens. For example, when the first account purchases 100 tokens from the management account, the processor 210 may transmit 100 first subtokens and 100 second subtokens to the first account. In an embodiment, the processor 210 may increase each of the number of owned first subtokens and the number of owned second subtokens of the first account by 100, and may reduce each of the number of owned first subtokens and the number of owned second subtokens of the management account by 100.

In an embodiment, the server 110 may store information related to the first subtoken and the second subtoken owned by the first account. For example, the processor 210 of the node 141 may transmit information that the first account owns 100 first subtokens and 100 second subtokens to the server 110. The server 110 may receive and store the information. According to an embodiment, storing information related to a first subtoken and a second subtoken owned by an account in the server 110 rather than a blockchain network 140 may save costs (e.g., a gas fee) in storing the information in the blockchain network 140.

In an embodiment, a subtoken may be configured in a form other than a token. For example, a subtoken may be a data block related to a token. For example, a subtoken may be configured in a functional unit of a token. For example, the first subtoken (or first data block) corresponding to the token may be configured for a token ownership transfer function, and the second subtoken (or second data block) may be configured for a token rental function.

In an embodiment, the processor 210 may provide an occupation reward to the first account that occupies the token. In the present disclosure, “occupation of a token,” unlike owning a token, may be a token control form in which a token owner and a token occupier may be different. For example, both an owner and an occupier of the token may be the first account, or the owner of the token may be the first account and the occupier of the token may be the second account. For example, the first account owning the second subtoken corresponding to the token may be an account that occupies the token. For example, the first account owning the first subtoken corresponding to the token may be an account that owns the token. The occupation reward may be a reward provided to an account that occupies the token. For example, the occupation reward may be a reward provided to an account that owns the second subtoken.

In an embodiment, at least one of a basic reward or an additional reward may be provided to the account that owns the first subtoken. For example, “providing a reward to an account” may mean that the processor 210 of the node 141 executes an instruction to change reward information corresponding to the account. The instruction may be included in the smart contract or a separate smart contract. In this case, the processor 210 may transmit the changed reward information to the server 110 or a user terminal corresponding to the account. For example, when the basic reward is provided to the account that owns the first subtoken, the processor 210 may execute a smart contract including an instruction to change information related to the basic reward of the account.

The basic reward may be a reward provided to the account that owns the first subtoken regardless of a degree to which an owner of the first subtoken contributes to an increase in value of real property. For example, the basic reward may include a portion of a profit according to a specified ratio as the profit (e.g., a rental fee) is generated from the real property. The additional reward may be a reward provided to the owner of the first subtoken according to the degree to which the owner of the first subtoken contributes to the increase in the value of the real property, that is, a real property value contribution degree.

In an embodiment, at least one of a first reward or a second reward may be provided to the account that owns the second subtoken. The second subtoken may be a token that can be rented to a different account, while the first subtoken may be a token with a restriction that prohibits rental of the token to a different account. The first subtoken may have a restriction that the first subtoken can only belong to the account that owns the token. Various methods may be configured to set a restriction that a token or subtoken belongs to a specific account, and may include, for example, a form that includes an instruction to set transmission of a token or subtoken from an account to another account to be prevented in a smart contract executed by a processor. However, a specific configuration method is not limited to the above example. In addition, a server or a user terminal may set a restriction that a token or subtoken belongs to a specific account, and various methods configurable or modifiable by a person skilled in the art may be used.

In an embodiment, the first reward or the second reward may be provided to the account that owns the second subtoken depending on whether a predetermined condition is satisfied. For example, when the second account owns the second subtoken corresponding to the token owned by the first account as the first account and the second account make a rental contract to be described below, the predetermined condition may be determined based on information about the first account that owns the token corresponding to the second subtoken. In another embodiment, the predetermined condition may be determined based on information on the second account that owns the second subtoken.

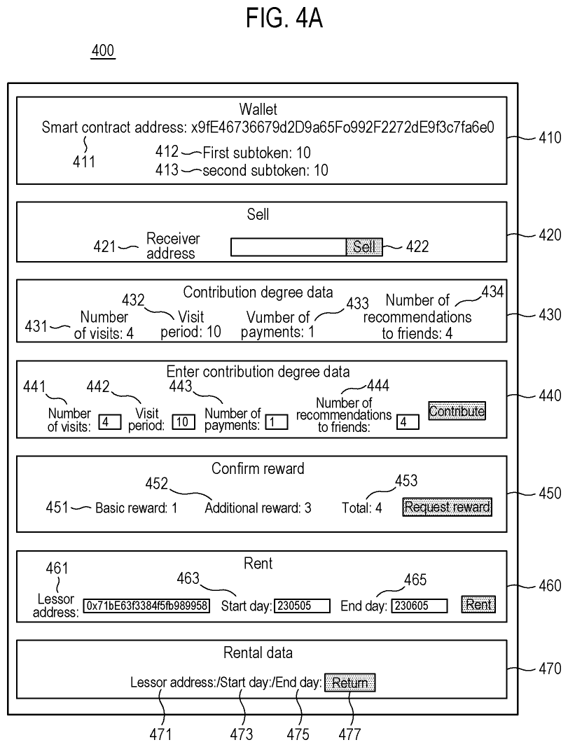

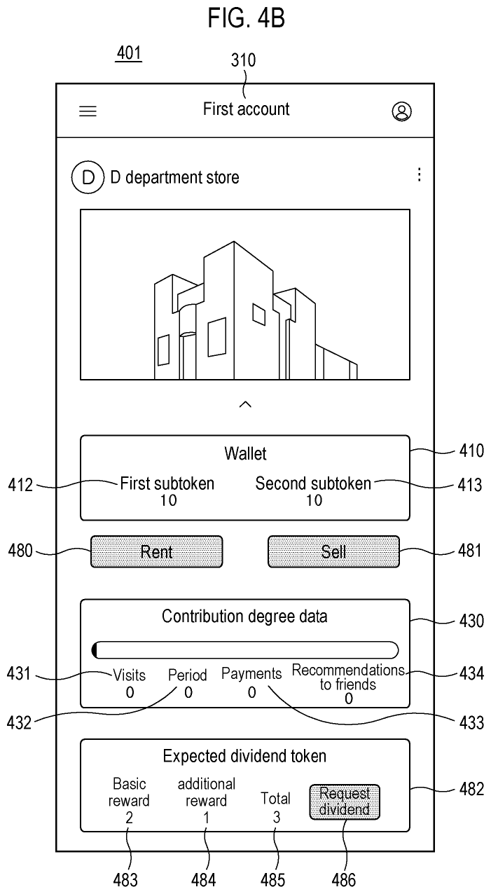

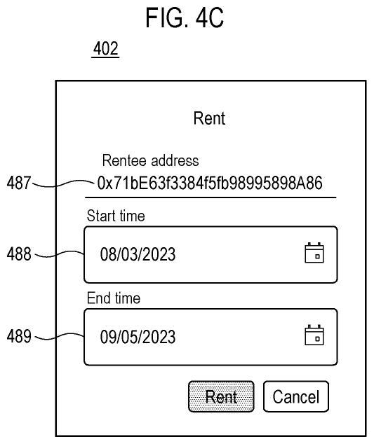

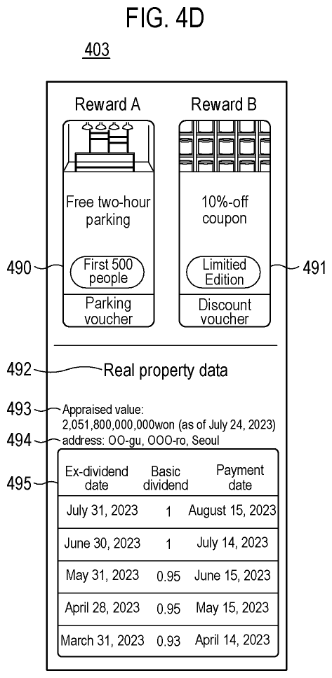

For example, when the predetermined condition is determined based on location information about the second account, the first reward may be a reward provided to a token owner residing within a predetermined distance from the real property or a person that rents the token from the token owner, and the second reward may be a reward provided to a token owner residing outside a predetermined distance from the real property or a person that rents the token from the token owner. In another embodiment, the predetermined condition may be determined based on time information designated by the management account regardless of the information about the first account or the second account. A detailed description of a reward classification criterion and a reward type will be described later with reference to FIG. 4D.

The first account and the second account according to an embodiment may make a token rental contract. The token rental contract may refer to an agreement that the first account rents some tokens owned by the first account to the second account. When the rental contract is made, a first subtoken of a token to be rented remains in a wallet of the first account, and only a second subtoken corresponding to the first subtoken may be transmitted to the second account. In an embodiment, the server 110 may generate rental data for the token rental contract and transmit the rental data to the processor 210, or the user terminal of the first account or the user terminal of the second account may directly transmit rental data for the token rental contract to the processor 210. Alternatively, an external server may generate rental data for the token rental contract and transmit the rental data to the processor 210 through the server 110 or directly without going through the server.

As the rental contract is made, the first user terminal 120 of the first account may transmit the rental data for the token between the first account and the second account to the processor 210. The processor 210 may receive the rental data for the token between the first account and the second account from the first user terminal 120 of the first account (320). The rental data may include data related to rental of the token. The rental data may include the number of second subtokens to be rented, a rental period, a wallet address of the first account, and a wallet address of the second account. For example, when the first account rents 10 second subtokens to the second account from Aug. 1, 2023 to Dec. 1, 2023, the rental data may include at least one of information indicating that a lessor account is the first account, the wallet address of the first account, information indicating that a rentee account is the second account, the wallet address of the second account, or information indicating that the rental period is from Aug. 1, 2023 to Dec. 1, 2023.

The processor 210 may store the received rental data in response to receiving the rental data (330). The processor 210 may store the rental data in the blockchain network 140. To this end, the processor 210 may execute a smart contract that includes an instruction to store the rental data in the blockchain network 140. For example, when the blockchain network 140 is an Ethereum-based network, the processor 210 may store the rental data in a database (e.g., Level DB). However, the type of a used database may vary depending on the type of the blockchain network 140, without being limited to the above example.

In an embodiment, the processor 210 may transmit the rental data to the server 110, and the server 110 may store the rental data. For example, to save costs (e.g., a gas fee) required to use the blockchain network 140, the rental data may not be recorded in the blockchain network 140 but may be stored only in the server 110.

The processor 210 may transmit the second subtoken to the second account. For example, 10 second subtokens may be transmitted to the second account, based on the wallet address of the second account and the information that the number of second subtokens to be rented is 10 among the rental data. In an embodiment, according to a method for transmitting the second subtoken to the second account, the processor 210 may subtract the number of second subtokens to be rented from the number of second subtokens owned by the first account, and may increase the number of second subtokens owned by the second account by the number (340). Specifically, the processor 210 may execute an instruction to subtract the number of second subtokens to be rented from the number of second subtokens owned by the first account and to increase the number of second subtokens owned by the second account by the number. For example, when the number of second subtokens to be rented is 10, the processor 210 may subtract 10 from the number of second subtokens owned by the first account, and may increase the number of second subtokens owned by the second account by 10.

The processor 210 may provide the first reward or the second reward only to an account having the second subtoken. When the second subtoken has been transmitted to the second account, the processor 210 may provide the first reward or the second reward to the second account. When the second subtoken has been transmitted to the second account, the first account may not be able to use at least one of the first reward or the second reward corresponding to the transmitted second subtoken.

In another embodiment, the token may correspond to a first subtoken, a second subtoken, and a third subtoken. The first subtoken may correspond to a basic reward and an additional reward, the second subtoken may correspond to a first reward, and the third subtoken may correspond to a second reward. The processor 210 may transmit the third subtoken to the second account in response to receiving rental data for the third subtoken between the first account and the second account.

In an embodiment, according to a method for transmitting the third subtoken to the second account, the processor 210 may execute an instruction to subtract the number of third subtokens to be rented from the number of third subtokens owned by the first account and to increase the number of third subtokens owned by the second account by the number. For example, when the number of third subtokens to be rented is 10, the processor 210 may subtract 10 from the number of third subtokens owned by the first account, and may increase the number of third subtokens owned by the second account by 10.

For example, when the third subtoken is transmitted to the second account, the processor 210 may provide the second reward to the second account. When the second subtoken has been transmitted to the second account, the processor 210 may provide the first reward to the second account. In another example, the token owner may rent the second subtoken corresponding to the first reward and the third subtoken corresponding to the second reward to different accounts. For example, the first account may rent the second subtoken to the second account and the third subtoken to an account other than the first account and the second account.

The second user terminal 130 of the second account may generate real property value contribution degree data of the second account. A real property value contribution degree (or contribution degree) may refer to a degree to which a specific account has contributed to an increase in value of real property corresponding to a token. The real property value contribution degree may be determined based on at least one of the number of visits to the real property, a visit period, an amount spent on the real property, the number of recommendations of the real property to other accounts, or the number of promotions through social networks. The foregoing factors that determine the real property value contribution degree are only examples, and other factors may also be included. For example, the real property value contribution degree may increase as the number of visits, an amount spent, the number of payments, the number of recommendations, or the number of promotions increases. The real property value contribution degree may be determined based on an action of a user increasing the value of the real property. For example, a factor that increases the value of the real property (e.g., an appraised value or a rental fee) may include an increase in the number of visitors to a store located in the real property or nearby stores, an increase in sales, and the like. Therefore, an action of the user visiting the real property, purchasing a product at the store located in the real property, or recommending the real property to other users may be an action that contributes to an increase in the value of the real property. A total value contribution degree may be the sum of real property value contribution degrees of all accounts owning a token corresponding to a share of the real property. Real property value contribution degree data may include information indicating a real property value contribution degree. The second user terminal 130 of the second account may generate the real property value contribution degree data of the second account, and may transmit the same to the processor 210. The real property value contribution degree data may be generated based on at least one of location information about the user terminal, payment information about a user, and a terminal usage record of the user. The processor 210 of the node 141 may receive the real property value contribution degree data of the second account from the second user terminal 130 of the second account (350). In another embodiment, the real property value contribution degree data may be generated in the server 110, and the server 110 may transmit the generated real property value contribution degree data to the processor 210. In still another embodiment, the real property value contribution degree data may be generated in an external server and transmitted to the server 110 or directly transmitted to the processor 210 without involvement of the server 110. The processor 210 may update real property value contribution degree data of the first account, based on the real property value contribution degree data of the second account (360). The processor 210 may update the real property value contribution degree data of the first account by adding a contribution degree included in the real property value contribution degree data of the second account to a contribution degree included in the real property value contribution degree data of the first account. That is, when the user of the second account that has rented the token from the first account, which is the token owner, contributes to an increase in the value of the real property, the contribution degree of the user of the second account may belong to the contribution degree of the first account. For example, when the real property value contribution degree of the first account already recorded in the token is 20 and the contribution degree included in the real property value contribution degree data of the second account is 10, a contribution degree included in the updated real property value contribution degree data of the first account may be 30.

In an embodiment, the processor 210 may update the real property value contribution degree data of the first account by applying a specified weight to the real property value contribution degree data of the second account. For example, the specified weight may be applied to the real property value contribution degree data of the second account depending on whether user information about the second account satisfies a pre-specified condition, and then the real property value contribution degree data may be added to the real property value contribution degree data of the first account. The pre-specified condition may be a condition determining whether to apply the weight to the real property value contribution degree data. For example, the pre-specified condition may include whether the user information about the account is a national or a foreigner, whether the distance from the real property to a residence is within a predetermined distance, whether the number of payments exceeds a certain number, or the like.

The second user terminal 130 of the second account according to an embodiment may transmit a request for the first reward or the second reward to the processor 210. The processor 210 may receive the request for the first reward or the second reward from the second user terminal 130 (370). In response to the request for the reward, the processor 210 may verify whether rental of the second subtoken is valid, based on the rental data (380).

In an embodiment, the processor 210 may execute an instruction to verify whether the rental of the second subtoken is valid in response to the request for the reward. An operation of verifying validity of the rental may include at least one of an operation of verifying whether there is a record of the second account renting the token from the first account or an operation of verifying whether a rental period has expired. In this case, the request for the reward may further include time information. In an embodiment, the processor 210 may determine whether the rental period has expired by using the time information included in the received request for the reward, or the processor 210 may request validity verification of whether the rental period has expired from an external device processing an oracle procedure to go through a verification procedure by an oracle, and may receive a validity verification result.

In another embodiment, the operation of verifying the validity of the rental may be performed by the management terminal 170 or the server 110. The processor 210 may transmit a request to verify the validity of the rental to the management terminal 170 or the server 110, and may then receive a verification result from the management terminal 170 or the server 110. In another embodiment, the user terminal may transmit the request for the reward to the server 110, and the server 110 may perform an operation of verifying the validity of the rental and then transmit a validity verification result to the processor 210 of the node 141.

When the rental is valid (e.g., when the rental period has not expired or when there is a record of the second account renting the token), the processor 210 may provide the first reward or the second reward to the second account. When the rental is not valid, the processor 210 may transmit a reward payment rejection message to the second account.

A restriction that a specific reward (e.g., the first reward and the second reward) is rented to a different account and other rewards (e.g., the basic reward and the additional reward) are not rentable may be technically configured by setting different rewards respectively for a plurality of subtokens corresponding to the token and matching a reward rentable to a different user to a specific subtoken.

In an embodiment, the smart contract executed by the processor 210 may be divided into a first smart contract and a second smart contract. The smart contract may be configured to be divided into a plurality of smart contracts in a unit of performing a specific function, and may be configured such that one smart contract performs all functions. Operations of the smart contract may be dividedly performed by the first smart contract and the second smart contract. In an embodiment, the processor 210 of the node 141 may execute both the first smart contract and the second smart contract. In an embodiment, the first smart contract may be executed by the processor 210 of the node 141, and the second smart contract may be executed by a processor (e.g., a second processor) included in a node different from the node 141. In an embodiment, the processor 210 of the node 141 and the second processor of the different node may execute both the first smart contract and the second smart contract through distributed computing. In an embodiment, at least one of the first smart contract or the second smart contract may be an upgradeable smart contract. When a system is to be modified for at least one of token issuance, subtoken management, rental, or reward payment through the upgradeable smart contract, the server 110 may upgrade the smart contract by a method of redistributing the smart contract including an instruction to be modified to the blockchain network 140.

The first user terminal 120 of the first account may transmit the rental data for the token between the first account and the second account to the processor 210. The processor 210 may execute the first smart contract to transmit the second subtoken to the second account. For example, the processor 210 may execute the first smart contract to transmit 10 second subtokens to the second account, based on the wallet address of the second account included in the rental data and the data that the number of second subtoken to be rented is 10. In an embodiment, the processor 210 may execute the first smart contract including an instruction to reduce the number of second subtokens owned by the first account by the number of second subtokens to be rented and to increase the number of second subtokens owned by the second account by the number of second subtokens to be rented in response to receiving the rental data. For example, when the number of second subtokens to be rented is 10, the processor 210 may reduce the number of second subtokens owned by the first account by 10, and may increase the number of second subtokens owned by the second account by 10.

The processor 210 may execute the first smart contract to transmit the rental data for the token between the first account and the second account to the second smart contract. The processor 210 may execute the second smart contract to store the rental data in the blockchain network. The second smart contract may include an instruction to store the rental data in the blockchain network. In another embodiment, the processor 210 may execute the second smart contract to transmit the rental data to the server 110 so that the rental data is stored in the server 110.

The second user terminal 130 of the second account may transmit the real property value contribution degree data of the second account to the processor 210. The processor 210 may execute the first smart contract to update the real property value contribution degree data of the first account, based on the real property value contribution degree data of the second account. The processor 210 may execute the first smart contract to update the real property value contribution degree data of the first account by adding the contribution degree included in the real property value contribution degree data of the second account to the contribution degree included in the real property value contribution degree data of the first account.

The second user terminal 130 of the second account may transmit a request for the first reward or the second reward to the processor 210. The processor 210 may execute the first smart contract to transmit a request to verify the validity of the rental to the second smart contract. In response to the request to verify the validity of the rental, the processor 210 may execute the second smart contract to verify whether the rental of the second subtoken is valid. An operation of verifying the validity of the rental may include at least one of an operation of verifying whether there is a record of the second account renting the token from the first account or an operation of verifying whether a rental period has expired. The processor 210 may execute the second smart contract to transmit a result of verifying the validity of the rental to the first smart contract. The processor 210 may execute the first smart contract to verify the validity of the rental, based on the result of verifying the validity of the rental. When the rental is valid (e.g., when the rental period has not expired or when there is a record of the second account renting the token), the processor 210 may provide the first reward or the second reward to the second account. When the rental is not valid, the processor 210 may transmit a reward payment rejection message to the second user terminal 130 of the second account.

FIG. 4A to FIG. 4D illustrate screens of a user terminal of a token owner according to various embodiments of the present disclosure.

FIG. 4A may be a screen displayed on a first user terminal 120 connected with a first account according to an embodiment. A screen 400 may display at least one of a wallet area 410, a token sale area 420, a contribution degree data area 430, a contribution degree data input area 440, a reward confirmation area 450, a token rental area 460, or a rental data display area 470.

The wallet area 410 may be an area in which information about a wallet of the first account is displayed. The wallet area 410 may display information about a smart contract address 411, the number 412 of first subtokens owned by the first account, and the number 413 of second subtokens owned by the first account. In an embodiment, the processor 210 may execute a smart contract including an instruction to return the number 412 of tokens and the number 413 of second subtokens in response to a request about the number 412 of first subtokens owned by the first account and the number 413 of second subtokens owned by the first account. The returned information may be transmitted to the first user terminal 120. The smart contract address 411 may correspond to the address of the smart contract in FIG. 4A.

The token sale area 420 may provide an interface for selling a token. The token sale area 420 may display information about a wallet address 421 of a token buyer and a sell object 422. In an embodiment, the processor 210 may execute a smart contract including an instruction to reduce the number of first subtokens and/or second subtokens owned by a seller by a selling amount and to increase the number of first subtokens and/or second subtokens owned by a buyer by the selling amount in response to a selling request corresponding to the sell object 422. When the sell object 422 is selected, as many tokens as the quantity of tokens to be sold among tokens owned by the first account may be transmitted to the wallet address 421 of the token buyer (e.g., a third account).

The contribution degree data area 430 may be an area in which information about a contribution degree (or real property value contribution degree) of the first account is displayed. The contribution degree data area 430 may display the number 431 of visits, a visit period 432, the number 433 of payments, and the number 434 of recommendations. In an embodiment, the processor 210 may execute a smart contract including an instruction to return information about the contribution degree of the first account (e.g., the number 431 of visits, the visit period 432, the number 433 of payments, and the number 434 of recommendations) in response to a contribution degree Confirmation request. The returned information may be transmitted to the first user terminal 120.

The contribution degree data input area 440 may be an area for a user of the first account to input a contributive action performed by the user. For example, the user may input at least one of the number 441 of visits, a visit period 442, the number 443 of payments, or the number 444 of recommendations. The user of the first account may update rental data for the first account through the contribution degree data input area 440. In an embodiment, the processor 210 may execute a smart contract including an instruction to update contribution degree data of the first account in response to a contribution degree update request.

The reward confirmation area 450 may be an area for checking a reward received by the user, and may be an area in which a received reward is displayed. The reward confirmation area 450 may include at least one of a basic reward 451, an additional reward 452, or a total reward 453. The total reward may be a result of adding the basic reward 451 and the additional reward 452. In an embodiment, the processor 210 may execute a smart contract including an instruction to return information about a reward provided to the first account in response to a reward confirmation request. The returned information may be transmitted to the first user terminal 120.

The token rental area 460 may be an area for inputting information necessary to rent a token to a different account. The token rental area 460 may include a wallet address 461 of an account renting a token, a rental start time 463, and a rental end time 465. The user may input the wallet address 461 of the account renting the token, the rental start time 463, and the rental end time 465. When the user selects a rent object 467, a second subtoken may be transmitted to the wallet address 461 of the account renting the token rental, based on input rental data. In an embodiment, the processor 210 may execute a smart contract including an instruction to store the rental data in a server 110 and/or a blockchain network 140, to reduce the number of tokens owned by the first account by the number of tokens to be rented, and to increase the number of tokens owned by the account renting the token in response to a token rental request.

The rental data display area 470 may be an area in which rental data for a token rented to a different account is displayed. At least one of the number (not shown) of second subtokens to be rented, a rental period 473 and 475, a wallet address (not shown) of the first account, a wallet address 471 of the second account, or a return object 477 may be included. When the return object is selected, a certain number of second subtokens to be rented corresponding to the selected return object may be transmitted to the wallet address of the first account. In an embodiment, the processor 210 may execute a smart contract including an instruction to return the rental data (e.g., the number of second subtokens to be rented, the rental period, the wallet address of the first account, and the wallet address of the second account) in response to a rental data confirmation request. The returned information may be transmitted to the first user terminal 120.

FIG. 4B may be a screen displayed on the first user terminal 120 connected with the first account according to another embodiment. The screen 401 may include at least one of a wallet area 410, a rent object 480, a sell object 481, a contribution degree data area 430, or an expected dividend token area 482. The wallet area 410 may display the number 412 of first subtokens and the number 413 of second subtokens. When a token corresponds to a first subtoken, a second subtoken, and a third subtoken, the number of third subtoken may be further displayed. Alternatively, only the number of tokens may be displayed without displaying the number of subtokens. The rent object 480 may provide an interface for renting a token. When the sell object 481 is selected, the user of the first account may sell tokens owned by the user to a different user. The contribution degree data area 430 in FIG. 4B is the same as the contribution degree data area 430 of FIG. 4A, and is thus omitted from the detailed description of the drawing. The expected dividend token area 482 may be an area in which a basic reward and an additional reward expected to be received by the first account during a specific period are displayed. A criterion and method for distinguishing the basic reward and the additional reward may vary. In an embodiment, the basic reward may be a reward provided equally to token owners in proportion to the amount of owned tokens, and the additional reward may be a reward provided differentially to the token owners, based on user information about the token owners. In another embodiment, the basic reward and the additional reward may be distinguished according to a predetermined condition previously specified by a management account regardless of the user information. The management account may provide the basic reward to the token owners during a first period and the additional reward to the token owners during the second period, based on information on a pre-specified period. For example, referring to FIG. 4B, the expected dividend token area 482 may include a basic reward 483 that the first account is expected to receive during the first period, an additional reward 484 that the first account is expected to receive during the second period, and a sum 485 of the basic reward and the additional reward. A dividend request object 486 may be an object for a request for the first account to receive the basic reward or the additional reward even before the first or second period expires. In another embodiment, the dividend request object may be displayed on a user terminal of the management account. In this case, the dividend request object displayed on the user terminal of the management account may be an object for requesting the processor 210 to provide a reward to other accounts at once.

A screen 402 of FIG. 4C may be a screen displayed when the rent object 480 is selected on the screen 401. The screen 402 may display objects for inputting an wallet address 487 of a second account, a rental start time 488, and a rental end time 489. In an embodiment, a reward type may be a form of a token, or may not be a form of a token. FIG. 4D illustrates a reward token not in a form of a token. A screen 403 of FIG. 4D may display reward A 490 corresponding to a parking voucher and reward B 491 corresponding to a discount voucher. Reward A 490 and reward B 491 may be a first reward or a second reward. A real property data area 492 displayed on the screen 403 may be an area in which data related to real property is displayed. The real property data area 492 may display at least one of an appraised value 493 of the real property, an address 494 of the real property, or a real property-related dividend detail 495. In an embodiment, the appraised value 493 of the real property may be data that has gone through a verification process by an oracle. The oracle may refer to predetermined data processing performed to increase reliability of data in a process of bringing the data outside a blockchain network into the blockchain network. For example, when the data is forged in the process of entering into the blockchain network, it may be difficult to rely on the data even though the data is managed as a blockchain, and thus a solution, such as the oracle, may be needed. Users may rely on the appraised value 493 of the real property through the verification process by the oracle.

Although a classification criterion may be set such that the first reward and the second reward are provided differently depending on whether a user lives within a predetermined distance from the real property, the classification criterion for rewards may vary, and reward types may vary accordingly. For example, the classification criterion for rewards may include classification criteria according to whether a user is a national or a foreigner, an amount spent in a store located in the real property, or the number of payments. Alternatively, a different reward may be provided depending on whether a user is a traveler or a local resident, based on whether a predetermined condition is satisfied.

The first reward according to an embodiment may be provided to an account that has completed verification of a first qualification proving residence within a predetermined distance (e.g., 1 km, 5 km, or a unit of an administrative district) from the real property. For example, when the real property is located in Songpa-gu, Seoul, the first reward may be provided to an account that has completed verification of a first qualification proving residence in Songpa-gu, Seoul. The first reward may encourage users residing adjacent to the real property to visit the real property and may further contribute to an increase in a value of the real property. The first reward may include, for example, at least one of a benefit of using a parking space of the real property (e.g., a free parking voucher), a benefit of using a store located in the real property (e.g., a discount voucher for a product sold in the store), or a benefit of using a store located within a predetermined distance from the real property. Providing not only the benefit of using the store located in the real property but also the benefit of the store located within the predetermined distance from the real property may vitalize a business area adjacent to the real property, which may lead to an increase in the value of the real property (e.g., an increase in rental fee and an increase in the appraised value of the real property).

The processor 210 according to an embodiment may provide a first reward for a second subtoken to the first account. For example, when the first account owns 10 second subtokens, the processor 210 may provide 10 first rewards for the second subtokens to the first account. The provided 10 first rewards may be of the same type or different types.

The second reward according to an embodiment may be provided to an account that has completed verification of a second qualification proving residence outside a predetermined distance from the real property. For example, a tourist (e.g., a national or a foreigner) who stops by the real property may also contribute to an increase in the value of the real property. However, tourists may be less likely to reside within the predetermined distance from the real property. For example, the secondary reward may include at least one of a benefit of an escorting service, a benefit of using an accommodation in the real property (e.g., a free one-night accommodation and a benefit of using an amenity in an accommodation), a benefit of using public transportation related to the real property (e.g., a limousine service), or a benefit of using a store located in the real property (e.g., a restaurant reservation priority and a mobile waitlist).

The processor 210 according to an embodiment may provide a second reward for the second subtoken to the first account. For example, when the first account owns 10 second subtokens, the processor 210 may provide 10 second rewards to the first account. The provided 10 second rewards may be of the same type or different types.

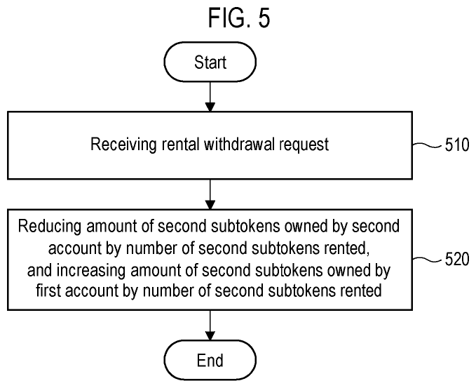

FIG. 5 is a flowchart illustrating a method of withdrawing a token upon expiration of a rental period according to an embodiment of the present disclosure.

Referring to FIG. 5, a rental may be withdrawn by a processor 210 executing a smart contract when a server 110 requests withdrawal of the rental from the processor 210 or a user terminal 120 of a first account requests withdrawal of the rental from the processor 210 upon expiration of a rental period. When the rental period expires, the processor 210 according to an embodiment may transmit a second subtoken transmitted to a second account to the first account. Specifically, the server 110 may determine whether the rental period has expired, based on rental data. When the rental period has expired as a result of determining whether the rental period has expired, the server 110 may transmit a rental withdrawal request to the processor 210 of a node 141. The processor 210 may receive the rental withdrawal request from the server 110 (510). The processor 210 may execute an instruction to withdraw the rented second subtoken in response to the rental withdrawal request. According to another embodiment, the processor 210 may receive a rental withdrawal request from the first user terminal 120 (510). The processor 210 may execute an instruction to withdraw the rented second subtoken in response to the rental withdrawal request. In another embodiment, when the rental period has expired as a result of determining whether the rental period has expired, the server 110 may transmit an inquiry request to the first user terminal 120 to inquire whether to withdraw the rental. The server 110 may transmit the rental withdrawal request to the processor 210 of the node 141, based on a response signal to the inquiry request. In this case, the processor 210 may execute an instruction to withdraw the rented second subtoken.

In an embodiment, the processor 210 may reduce the amount of second subtokens owned by a second account by the number of second subtokens rented, and may increase the amount of second subtokens owned by the first account by the number of second subtokens rented (520). Specifically, an operation of the processor 210 withdrawing the rented second subtoken may be performed by the processor 120 executing an instruction to reduce the amount of second subtokens owned by the second account by the number of second subtokens rented and to increase the amount of second subtokens owned by the first account by the number of second subtokens rented.

In an embodiment, the processor 210 may transmit a token withdrawal completion signal to at least one of the server 110, the first user terminal 120, or a second user terminal 130.

In another embodiment, the smart contract executed by the processor 210 may be divided into a first smart contract and a second smart contract. The first smart contract may receive a token withdrawal request from an external device (e.g., the server 110, the first user terminal 120, and/or the second user terminal 130), and may transmit a token withdrawal completion signal to the external device. The second smart contract may perform withdrawal of the rented second subtoken. The processor 210 of the node 141 may execute both the first smart contract and the second smart contract.

For example, the server 110 may determine whether the rental period has expired, based on the rental data. When the rental period has expired, the server 110 may transmit a rental withdrawal request to the processor 210. The processor 210 may execute the first smart contract in response to the rental withdrawal request. The processor 210 may execute the first smart contract to transmit the rental withdrawal request to the second smart contract. The processor 210 may execute the second smart contract to withdraw the rented second subtoken. For example, the processor 210 may execute the second smart contract including an instruction to reduce the amount of second subtokens owned by the second account by the number of second subtokens rented and to increase the amount of second subtokens owned by the first account by the number of second subtokens rented. The processor 210 may transmit a signal that withdrawal of the token has been completed as a result of executing the instruction to the first smart contract. The processor 210 may execute the first smart contract to transmit a token withdrawal completion signal to at least one of the server 110, the first user terminal 120, and the second user terminal 130.

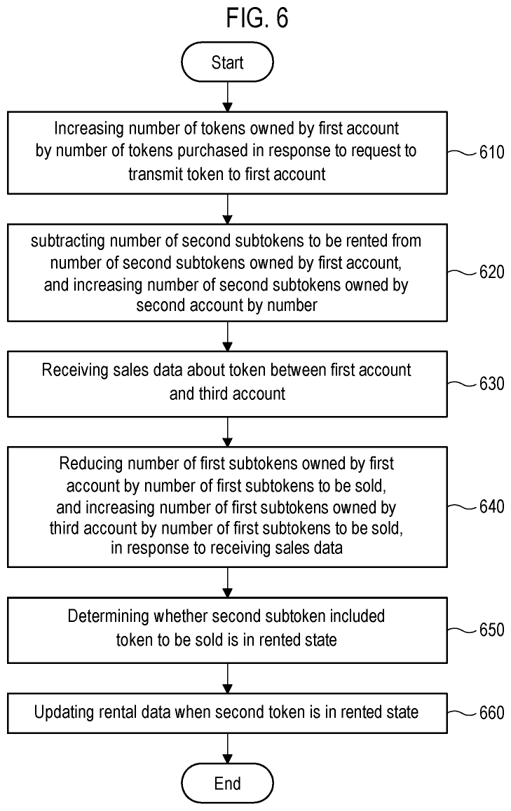

FIG. 6 is a flowchart illustrating a method of renting a token when a token is traded according to various embodiments of the present disclosure. According to an embodiment, when a token rental contract between a first account and a second account is concluded, a first user terminal 120 of the first account may transmit rental data for a token between the first account and the second account to a processor 210. The processor 210 may receive the rental data for the token between the first account and the second account (610). In response to receiving the rental data, the processor 210 may execute an instruction to transmit a second subtoken to the second account. In an embodiment, the processor 210 may subtract the number of second subtokens to be rented from the number of second subtokens owned by the first account, and may increase the number of second subtokens owned by the second account by the number (620). Specifically, the processor 210 may execute an instruction to subtract the number of second subtokens to be rented from the number of second subtokens owned by the first account and to increase the number of second subtokens owned by the second account by the number.

According to an embodiment, when a token sales contract is made between the first account and a third account, sales data about a token between the first account and the third account may be transmitted to the processor 210. The processor 210 may receive the sales data about the token between the first account and the third account (630). In an embodiment, the processor 210 may execute a smart contract including an instruction to store the sales data in a blockchain network 140. The sales data may include information about sale of a specific token. For example, the sales data may include at least one of a wallet address of the first account as a seller, a wallet address of the third account as a buyer, or the number of tokens to be sold. In an embodiment, when a token is sold, a first subtoken and a second subtoken corresponding to the token may be transmitted to the account (e.g., the third account) of the buyer. In an embodiment, in response to receiving the sales data, the processor 210 may reduce the number of first subtokens owned by the first account by the number of first subtokens to be sold, and may increase the number of first subtokens owned by the third account by the number of first subtokens to be sold (640). The processor 210 may execute an instruction to reduce the number of first subtokens owned by the first account by the number of first subtokens to be sold and to increase the number of first subtokens owned by the third account by the number of first subtokens to be sold in response to receiving the sales data. Likewise, the processor 210 may execute an instruction to reduce the number of second subtokens owned by the first account by the number of second subtokens to be sold and to increase the number of second subtokens owned by the third account by the number of second subtokens to be sold in response to receiving the sales data. In another embodiment, to save costs required to use the blockchain network, the sales data may not be recorded in the blockchain network 140 but be stored only in a server 110. In this case, the processor 210 may receive the sales data from the server, and may execute instructions executed in response to receiving the sales data.

The processor 210 may determine whether the second subtoken corresponding to the token to be sold is in a rented state (650). In response to receiving the sales data, the processor 210 may execute an instruction to determine whether the second subtoken is in the rented state. When the second subtoken is in the rented state, the processor 210 may transmit the first subtoken corresponding to the second subtoken to a third user terminal 160 of the third account. For example, when the second subtoken is in a state of being rented to the second account, only the first subtoken may be transmitted to the third account. In an embodiment, when the second subtoken is in the state of being rented to the second account, the processor 210 may execute an instruction to reduce the number of first subtokens owned by the first account by the number of first subtokens to be sold and to increase the number of first subtokens owned by the third account by the number of first subtokens to be sold. Further, the processor 210 may execute an instruction to reduce the number of second subtokens owned by the first account by the number of second subtokens to be sold excluding the number of second subtokens currently in the rented state and to increase the number of second subtokens owned by the third account by the number of second subtokens to be sold excluding the number of second subtokens currently in the rented state.

When the second token is in the rented state, the processor 210 may update the rental data (660). For example, the processor 210 may add the wallet address of the third account included in the rental data. In another example, the processor 210 may change the wallet address of the first account included in the rental data to the wallet address of the third account. When the second subtoken is not in the rented state, the processor 210 may transmit the first subtoken and the second subtoken to the third user terminal 160 of the third account. In an embodiment, when the second subtoken is not in the state of being rented to the second account, the processor 210 may execute an instruction to reduce the number of first subtokens owned by the first account by the number of first subtokens to be sold and to increase the number of first subtokens owned by the third account by the number of first subtokens to be sold. Further, the processor 210 may execute an instruction to reduce the number of second subtokens owned by the first account by the number of second subtokens to be sold and to increase the number of second subtokens owned by the third account by the number of second subtokens to be sold.

When the rental data is completely updated, the processor 210 may transmit a rental data update completion signal to at least one of the server 110, the first user terminal 120, the second user terminal 130, or the third user terminal 160.

In an embodiment, the smart contract executed by processor 210 may be divided into a first smart contract and a second smart contract. In an embodiment, the processor 210 of the node 141 may execute both the first smart contract and the second smart contract.

When the token rental contract between the first account and the second account according to an embodiment is made, the first user terminal 120 of the first account may transmit the rental data for the token between the first account and the second account to the processor 210. The processor 210 may execute the first smart contract to transmit the second subtoken to the second account.

When the token sales contract between the first account and the third account is made, sales data about the token between the first account and the third account may be transmitted to the processor 210. The processor 210 may execute the first smart contract in response to receiving the sales data.

The processor 210 may execute the first smart contract to determine whether the second subtoken corresponding to the token to be sold is in the rented state. When the second subtoken is in the rented state, the processor 210 may transmit the first subtoken corresponding to the second subtoken to the third account. For example, when the second subtoken is in the state of being rented to the second account, only the first subtoken may be transmitted to the third account. In an embodiment, when the second subtoken is in the state of being rented to the second account, the processor 210 may execute the first smart contract including an instruction to reduce the number of first subtokens owned by the first account by the number of first subtokens to be sold and to increase the number of first subtokens owned by the third account by the number of first subtokens to be sold. Further, the processor 210 may execute the first smart contract including an instruction to reduce the number of second subtokens owned by the first account by the number of second subtokens to be sold excluding the number of second subtokens currently in the rented state and to increase the number of second subtokens owned by the third account by the number of second subtokens to be sold excluding the number of second subtokens currently in the rented state.

When the second subtoken is in the rented state, the processor 210 may request update of the rental data from the second smart contract. The processor 210 may update the rental data by executing the second smart contract. For example, the processor 210 may execute the second smart contract to add the wallet address of the third account included in the rental data. In another example, the processor 210 may execute the second smart contract to change the wallet address of the first account included in the rental data to the wallet address of the third account. When the rental data is completely updated, the processor 210 may execute the second smart contract to transmit a rental data update completion signal to the first smart contract. The processor 210 may execute the first smart contract to transmit the rental data update completion signal to at least one of the server 110, the first user terminal 120, the second user terminal 130, or the third user terminal 160.

When the second subtoken is not in the rented state, the processor 210 may transmit the first subtoken and the second subtoken to the third account. In an embodiment, when the second subtoken is not in the state of being rented to the second account, the processor 210 may execute the first smart contract including an instruction to reduce the number of first subtokens owned by the first account by the number of first subtokens to be sold and to increase the number of first subtokens owned by the third account by the number of first subtokens to be sold. Further, the processor 210 may execute the second smart contract including an instruction to reduce the number of second subtokens owned by the first account by the number of second subtokens to be sold and to increase the number of second subtokens owned by the third account by the number of second subtokens to be sold.

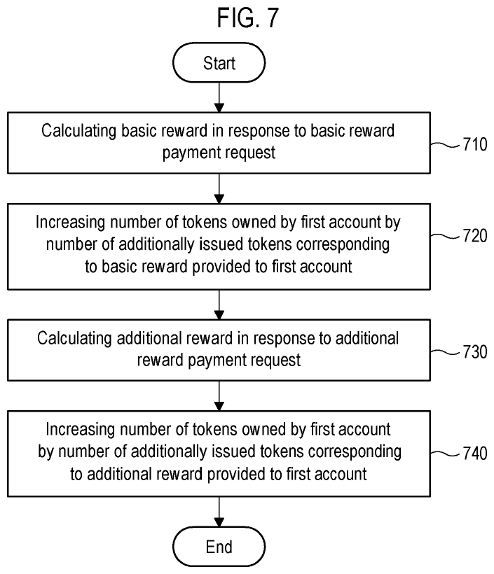

FIG. 7 illustrates a method of providing a basic reward and an additional reward according to various embodiments of the present disclosure. A processor 210 according to an embodiment may provide a basic reward for a first subtoken to a first account every first period (e.g., one month, three months, six months, or one year).

In an embodiment, the processor 210 may determine whether the first period expires at regular intervals. In another embodiment, a server 110 and/or a first user terminal 120 may determine whether the first period expires. In this case, the server 110 and/or the first user terminal 120 may transmit a basic reward payment request to the processor 210 of a node 141. The processor 210 may execute an instruction to determine whether the first period expires in response to the reward payment request.

When the first period expires, the processor 210 may calculate the basic reward in response to the basic reward payment request. In an embodiment, the processor 210 may execute an instruction to calculate the basic reward. The processor 210 may determine, as the basic reward, the number of tokens determined according to a ratio of the number of tokens owned by the first account to the total number of issued tokens among the number of additionally issued tokens corresponding to a profit in the first period determined based on at least one of a profit from using real property (e.g., a rental fee) or a profit margin from selling the real property. The additionally issued tokens may be the same as the existing issued tokens or may be different tokens. For example, when the number of additionally issued tokens corresponding to the profit is determined to be 100, the total number of issued tokens is 10,000, and the number of tokens owned by the first account is 10, the basic reward provided to the first account may be the number of additionally issued tokens of 100*0.01 ( 10/10,000)=1 token. The processor 210 according to an embodiment may provide the basic reward to the first account, based on a result of calculating the basic reward. In an embodiment, the processor 210 may execute an instruction to change information related to the basic reward of the first account. For example, when the basic reward is an additionally issued token, the processor 210 may increase the number of tokens owned by the first account by the number of additionally issued tokens corresponding to the basic reward provided to the first account (720). Specifically, the processor 210 may execute an instruction to increase the number of tokens owned by the first account by the number of additionally issued tokens corresponding to the basic reward provided to the first account. For example, when the number of additionally issued tokens is 1, the processor 210 may execute an instruction to increase each of the number of first subtokens owned by the first account and the number of second subtokens owned by the first account by one.

The processor 210 according to an embodiment may provide an additional reward for the first subtoken to the first account every second period. In an embodiment, the processor 210 may determine whether the second period (e.g., one month, three months, six months, or one year) expires at regular intervals. In another embodiment, the server 110 and/or the first user terminal 120 may determine whether the second period expires. In this case, the server 110 and/or the second user terminal 120 may transmit an additional reward payment request to the processor 210. The processor 210 may execute an instruction to determine whether the second period expires in response to the additional reward payment request. The second period may be the same or different from the first period.

When the second period expires, the processor 210 may calculate the additional reward in response to the additional reward payment request. In an embodiment, the processor 210 may execute an instruction to calculate the additional reward. The processor 210 may determine the number of additionally issued tokens corresponding to the second period, based on total real property value contribution degree data generated based on pieces of real property value contribution degree data of a plurality of accounts owning a token. For example, when the real property value contribution degree of each of 10 accounts owning 10 tokens is 10, a total real property value contribution degree may be 10*10*10=1,000. According to an embodiment, when the total real property value contribution degree included in the total real property value contribution degree data exceeds a threshold contribution degree, the processor 210 may determine the number of additionally issued tokens, based on a contribution degree excess. For example, when the threshold contribution degree is 800 and the total real property value contribution degree is 1,000, the processor 210 may determine the number of additionally issued tokens, based on a contribution degree of an contribution degree excess of 200. An instruction for a method of determining the number of additionally issued tokens may be included in a smart contract. For example, the number of additionally issued tokens may be a number of a contribution degree multiplied by a certain ratio. For example, when the contribution degree excess is 200, the number of additionally issued tokens may be 20. The threshold contribution degree may be a value determined by a management account. The processor 210 may provide the first account's additional reward to the first account in response to a result of calculating the additional reward. When the total real property value contribution degree of token owners exceeds the threshold contribution degree, the processor 210 may provide the additional reward to the token owners in addition to the basic reward. Accordingly, the token owners may be encouraged to conduct a contributive action to increase the value of the real property.

The processor 210 according to an embodiment may provide the additional reward to the first account owning the first subtoken. In an embodiment, the processor 210 may execute an instruction to change information related to the additional reward for the first account. For example, when the additional reward is an additionally issued token, the processor 210 may increase the number of tokens owned by the first account by the number of additionally issued tokens corresponding to the additional reward provided to the first account (740). Specifically, the processor 210 may execute an instruction to increase the number of tokens owned by the first account by the number of additionally issued tokens corresponding to the additional reward provided to the first account. For example, when the number of additionally issued tokens is 10, the processor 210 may execute an instruction to increase each of the number of first subtokens owned by the first account and the number of second subtokens owned by the first account by 10.

The additional reward may be provided, for example, at regular intervals. The processor 210 may calculate a real property value contribution ratio of the first account, based on the updated real property value contribution degree data of the first account and the total real property value contribution degree data. The real property value contribution ratio may refer to a proportion of the real property value contribution degree of the first account to the total real property value contribution degree. For example, the contribution degree of the first account included in the updated real property value contribution degree data of the first account may be 10, and the total real property value contribution degree obtained by adding up the real property value contribution degrees of all accounts may be 1,000. In this case, the processor 210 may determine the real property value contribution ratio of the first account to be 10/1,000=0.01.

In an embodiment, the additional reward may be in a form of a token. The token may be a token of the same type as a token corresponding to the real property, or may be a random token unrelated to the real property. When the token is provided as the additional reward, the processor 210 may transmit a certain number of tokens among the number of additionally issued tokens to the first account, based on the calculated real property value contribution ratio of the first account. For example, when the number of additionally issued tokens corresponding to the second period is 100 and the real property value contribution ratio of the first account is 0.01, the number of additionally issued tokens transmitted to the first account may be 100*0.01=1.

According to an embodiment, the processor 210 may initialize the real property value contribution degree data of each of the plurality of accounts owning the token after completely providing the additional reward to the first account. For example, when the second period is six months and the additional reward corresponding to a period from Jan. 1, 2023 to Jun. 30, 2023 has been completely provided, the processor 210 may initialize real property value contribution degree data of each of the plurality of accounts corresponding to the period from Jan. 1, 2023 to Jun. 30, 2023. Therefore, the real property value contribution degree of each of the plurality of accounts in a next period from Jul. 1, 2023 may be 0. As a real property value contribution degree accumulates, an account owning a token for a long time may receive a greater additional reward. Initializing the real property value contribution degree every second period makes it possible to provide a method for an account newly owning a token to fairly receive an additional reward. Accordingly, the number of potential customers who seek to purchase a token may increase.

According to another embodiment, the smart contract executed by the processor 210 may be divided into a first smart contract and a second smart contract. In an embodiment, the processor 210 of the node 141 may execute both the first smart contract and the second smart contract.

The server 110 and/or the first user terminal 120 may determine whether the first period expires. In this case, the server 110 and/or the first user terminal 120 may transmit a basic reward payment request to the processor 210. The processor 210 may execute the first smart contract in response to the reward payment request.

When the first period expires, the processor 210 may execute the first smart contract to transmit a basic reward calculation request to the second smart contract. The processor 210 may execute the second smart contract to calculate the basic reward. The processor 210 may execute the second smart contract to transmit a result of calculating the basic reward to the first smart contract. The processor 210 may execute the first smart contract to provide the basic reward to the first account. In an embodiment, the processor 210 may execute the first smart contract including an instruction to increase the number of tokens owned by the first account by the number of tokens corresponding to the basic reward provided to the first account.

The second period may be the same as or different from the first period. The server 110 and/or the first user terminal 120 may determine whether the second period expires. In this case, the server 110 and/or the first user terminal 120 may transmit an additional reward payment request to the processor 210. The processor 210 may execute the first smart contract in response to the reward payment request.

When the second period expires, the processor 210 may execute the first smart contract to transmit an additional reward calculation request to the second smart contract. The processor 210 may execute the second smart contract in response to the reward payment request.

The processor 210 may execute the second smart contract to calculate the additional reward. The processor 210 may execute the second smart contract to transmit a result of calculating the additional reward to the first smart contract. The processor 210 may execute the first smart contract to provide the additional reward for the first account to the first account. In an embodiment, the processor 210 may execute the first smart contract including an instruction to increase the number of tokens owned by the first account by the number of tokens corresponding to the additional reward provided to the first account.

Although a token rental contract is made between the first account and the second account, only the second subtoken is transmitted to the second account and the first subtoken remains in the first account, and thus the basic reward and the additional reward for the first subtoken are not provided to the second account. In an embodiment, the processor 210 does not reduce the number of first subtokens owned by the first account and does not increase the number of first subtokens owned by the second account even when the rental contract is made. Thus, when the number of existing first subtokens owned by the second account is 0, the basic reward and the additional reward for the first subtoken may not be provided to the second account.

FIG. 8A and FIG. 8B illustrate screens of a user terminal connected to a management account 805 according to various embodiments of the present disclosure.

A screen 800 of FIG. 8A may display a wallet area 810, the number 812 of first subtokens, the number 813 of second subtokens, a token issue object 814, a token sell object 815, and/or the total number 816 of issued tokens. The wallet area 810 of the management account 805 may be an area in which information about a wallet of the management account 805 is displayed. The management account 805 may determine to issue an additional token. For example, the total number of tokens currently issued corresponding to a share of particular real property may be 14, and a user of the management account 805 may additionally issue five tokens through the issue object 814. The user of the management account 805 may sell the tokens to a first account through the token sell object 815.

The management account 805 according to an embodiment may transmit the number of issued tokens determined based on a user input to an address of a smart contract. The number of issued tokens may be a number input through the issue object 814.

FIG. 8B illustrates a screen displayed when the user of the management account 805 selects the token sell object 815. A token sale pop-up window 830 may display a wallet address 831 of a buyer (e.g., a first account) and a selling token quantity 832. The user of the management account 805 may input a wallet address of a buyer account and a selling token quantity to the wallet address 831 and the selling token quantity 832. In this case, as many tokens as the selling token quantity 832 may be transmitted to the wallet address 831.

According to another embodiment, a management terminal 170 corresponding to the management account 805 may receive a wallet address of the first account and a purchasing token quantity from a first user terminal 120 corresponding to the first account that is a token purchaser. The management terminal 170 may input the wallet address of the first account and the purchasing token quantity respectively to the wallet address 831 and the selling token quantity 832, based on data received from the first user terminal.

According to an embodiment, the management terminal 170 may transmit the wallet address of the first account and the purchasing token quantity to the address of the smart contract. Referring to FIG. 8A, the management terminal 170 may transmit the wallet address of the first account and the purchasing token quantity to the address of the smart contract.

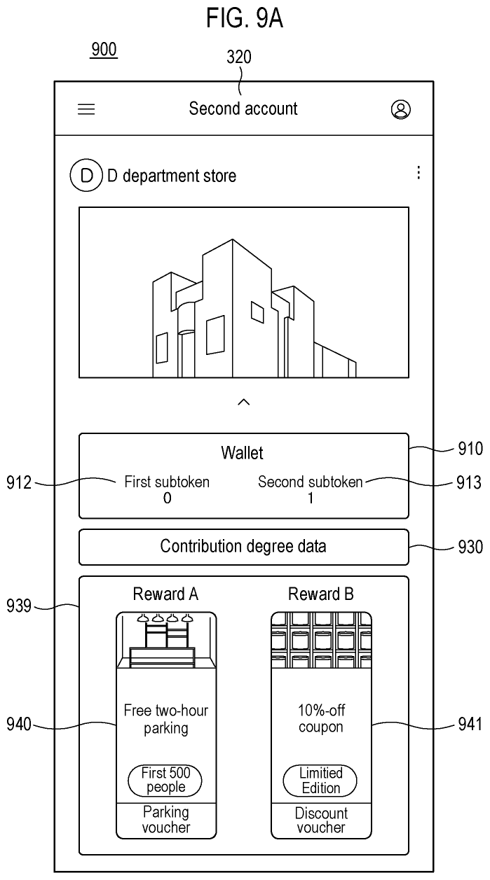

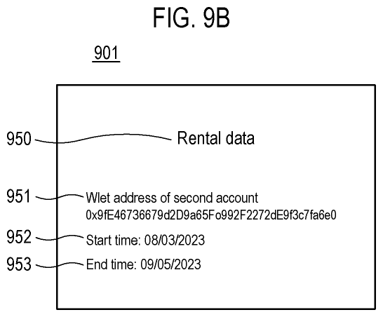

FIG. 9A and FIG. 9B illustrate screens of a user terminal connected to a second account renting a token from a first account according to various embodiments of the present disclosure.

On a screen 900 of FIG. 9A, a wallet area 910 of the second account may be an area in which information about a wallet of the second account is displayed. The wallet area 910 may display the number 912 of first subtokens and the number 913 of second subtokens. A contribution degree data area 930 may be an area in which information about a contribution degree (or real property value contribution degree) of the second account is displayed.

According to an embodiment, the second user terminal 130 corresponding to the second account may transmit a wallet address of the second account to a first user terminal 120 of the first account owning the token.

According to an embodiment, the second user terminal 130 may receive a user input to confirm a contribution degree, and may request real property value contribution degree data of the second account from a blockchain network. As a result, the contribution degree data area 930 of the second account may be displayed on the screen 900.

According to an embodiment, the second user terminal 130 may receive a user input to confirm a reward, and may output a first reward provided to the second account on the screen. For example, referring to FIG. 9A, the screen 900 may display a first reward (e.g., reward A 490 and reward B 491) provided to the second account. A reward display area 939 may be an area in which at least one of the first reward or a second reward provided to the second account is displayed. The reward display area 939 may display reward A 940 and reward B 941. For example, the second account may rent five second subtokens from the first account. In this case, reward A 940 and reward B 941 may be a reward corresponding to the second subtokens.

A screen 901 of FIG. 9B may include a rental data display area 950. The rental data display area 950 may be an area in which rental data for the token rented by the second account is displayed. The rental data display area 950 may include a wallet address 951 of the second account, a rental start time 952, and a rental end time 953.

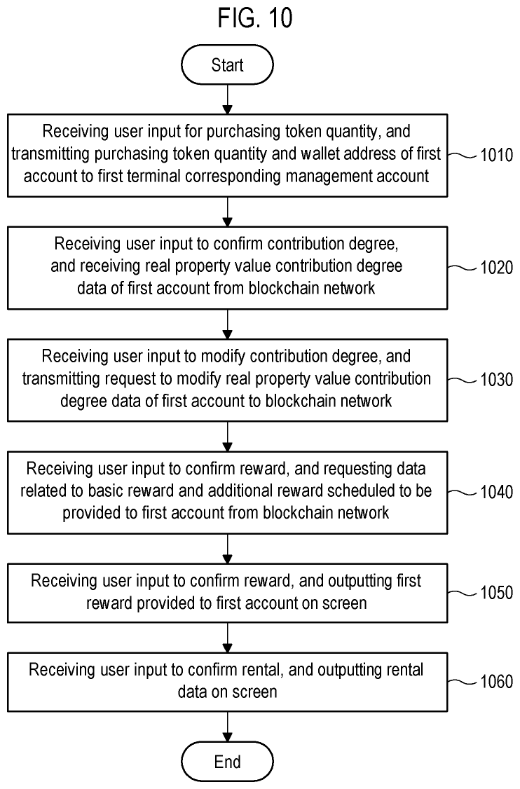

FIG. 10 is a flowchart illustrating an operation of a terminal (e.g., the first user terminal 120) of a token owner according to various embodiments of the present disclosure.

The first user terminal 120 may receive a user input for a purchasing token quantity, and may transmit the purchasing token quantity and a wallet address of a first account to a management terminal 170 corresponding to a management account (1010).

The first user terminal 120 may receive a user input to confirm a contribution degree, and may receive real property value contribution degree data of the first account from a blockchain network (1020). For example, referring to FIG. 4B, the contribution degree data may be real property value contribution degree data of the first account received from the blockchain network.

The first user terminal 120 may receive a user input to modify a contribution degree, and may transmit a request to modify the real property value contribution degree data of the first account to the blockchain network (e.g., a smart contract) (1030). For example, the first user terminal 120 may transmit the request to modify the real property value contribution degree data to a server 110, and the server 110 may transmit the request to modify the real property value contribution degree data to a processor 210. For example, a user of a first account may update the real property value contribution degree data through a contribution data input area 440.

The first user terminal 120 may receive a user input to confirm a reward, and may request data related to a basic reward and an additional reward scheduled to be provided to the first account from the blockchain network (e.g., the smart contract) (1040). For example, the user of the first account may confirm the basic reward and the additional reward scheduled to be provided through a reward confirmation area 450.

The first user terminal 120 may receive a user input to confirm a reward, and may output a first reward provided to the first account on a screen (1050). For example, the first reward (e.g., reward A 490 and reward B 491) may be displayed on the screen 403 of FIG. 4D.

The first user terminal 120 may receive a user input to confirm a rental, and may output rental data on the screen (1060). For example, when the user input to confirm the rental is received, a rental data display area 470 may be displayed on the screen 400 of FIG. 4A.

A method of providing a reward to a token owner according to an embodiment may include providing a reward to a first account owning a token, based on real property value contribution degree data of the first account. The reward provided to the first account may be an additional reward.

The method of providing the reward to the token owner may include providing an occupation reward to the first account that occupies the token. The occupation reward may be a first reward and/or a second reward.

The method of providing the reward to the token owner may include transmitting a token to a second account in response to receiving rental data for the token between the first account and the second account.

The method of providing the reward to the token owner may include providing a reward to the first account, based on real property value contribution degree data of the second account receiving the token. The reward provided to the first account may be an additional reward.

The method of providing the reward to the token owner may include providing an occupation reward to the second account that owns a token. The reward provided to the first account may be a first reward and/or a first reward.

According to at least one embodiment of the present disclosure, a reward may be provided to an owner of a token corresponding to a share of specific real property.

According to at least one embodiment of the present disclosure, the owner of the token may rent a subtoken to a different user.

According to at least one embodiment of the present disclosure, when a rentee of a subtoken conducts a contributive action of increasing a value of the real property, the contributive action may be applied to a contribution degree of the owner of the token.

According to at least one embodiment of the present disclosure, even when ownership of the token is transferred with a subtoken rented, the subtoken may remain in a rented state.

According to at least one embodiment of the present disclosure, a reward may be provided for rental of each of a plurality of subtokens according to different reward systems.

Effects according to the technical idea disclosed herein are not limited to the effects mentioned above, and other effects not mentioned will be clearly understood by those skilled in the art from the description of the present disclosure.

The methods according to the present disclosure may be methods implemented by a computer. The computer may include, for example, a device capable of performing processing. Although operations of the methods are shown and described in a predetermined order in the present disclosure, the operations may be performed according to an order in which the operations may be randomly combined in addition to being sequentially performed. In an embodiment, at least some operations may be performed in parallel, repeatedly, or heuristically. The present disclosure does not exclude changes or modifications to the methods. In an embodiment, at least some operations may be omitted, or other operations may be added.

Various embodiments of the present disclosure may be implemented in software recorded in a machine-readable recording medium. The software may be software for implementing various embodiments of the present disclosure. The software may be inferred from various embodiments of the present disclosure by programmers in the technical field to which the present disclosure belongs. For example, the software may be machine-readable instructions (e.g., code or code segments) or a program. A machine may be a device capable of operating according to instructions loaded from the recording medium, and may be, for example, a computer. In an embodiment, the machine may be a device according to embodiments of the present disclosure. In an embodiment, a processor of the machine may execute the loaded instructions to cause elements of the machine to perform functions corresponding to the instructions. In an embodiment, the processor may be a processor according to embodiments of the present disclosure. The recording medium may refer to any type of recording medium storing machine-readable data. The recording medium may include a ROM, a RAM, a CD-ROM, a magnetic tape, a floppy disk, an optical data storage device, and the like. In an embodiment, the recording medium may be a memory. In an embodiment, the recording medium may be configured in a distributed form in a computer system connected to a network. The software may be stored and executed in a distributed manner in the computer system. The recording medium may be a non-transitory recording medium. The non-transitory recording medium refers to a tangible medium regardless of storing data semi-permanently or temporarily, and does not include a transitorily transmitted signal.

Although the technical idea of the present disclosure has been described with reference to various embodiments, the technical idea of the present disclosure may include various substitutions, modifications, and changes that may be made within the scope of understanding by those skilled in the art to which the present disclosure belongs. Further, the substitutions, modifications, and changes should be understood as being included in the scope of the accompanying claims. The embodiments according to the present disclosure may be combined with each other. Various combinations of the embodiments may be made depending on a number of cases, and a combined embodiment may also be included in the scope of the present disclosure.

What is claimed is:

1. A method of providing a reward to a token owner, the method comprising:
executing, by a processor connected to a computer network including a blockchain network, a smart contract for providing a reward to an owner of a token corresponding to a share of real property,
wherein the smart contract includes:
an instruction to transmit a first subtoken and a second subtoken corresponding to the token to a first account;
an instruction to provide a first reward for the second subtoken to the first account;
an instruction to transmit the second subtoken to a second account in response to receiving first rental data for the token between the first account and the second account; and
an instruction to provide the first reward to the second account when the second subtoken has been transmitted to the second account.

2. The method of claim 1, wherein the smart contract further includes an instruction to provide a basic reward for the first subtoken corresponding to the second subtoken to the first account when the second subtoken has been transmitted to the second account.

3. The method of claim 1, wherein the first reward is provided to an account that completes a first qualification proving residence within a predetermined distance from the real property.

4. The method of claim 1, wherein the smart contract further includes:
an instruction to provide a second reward for the second subtoken to the first account; and
an instruction to provide the second reward to the second account when the second subtoken has been transmitted to the second account.

5. The method of claim 4, wherein the second reward is provided to an account that completes a second qualification proving residence outside a predetermined distance from the real property.

6. The method of claim 1, wherein the token further corresponds to a third subtoken, and
the smart contract further includes:
an instruction to provide at least one of the first reward or a second reward to the second account;
an instruction to transmit the third subtoken to the second account in response to receiving second rental data for the third subtoken between the first account and the second account; and
an instruction to provide the second reward to the second account when the third subtoken has been transmitted to the second account.

7. The method of claim 1, wherein the instruction to transmit the second subtoken to the second account includes:
an instruction to store the first rental data for the token including a number of second subtokens to be rented, a rental period, a wallet address of the first account, and a wallet address of the second account in the blockchain network in response to receiving the first rental data for the token.

8. The method of claim 7, wherein the smart contract further includes:
an instruction to transmit the second subtoken transmitted to the second account to the first account when the rental period expires.

9. The method of claim 1, wherein the smart contract further includes:
an instruction to transmit the first subtoken corresponding to the second subtoken to a third account when the first account assigns the token corresponding to the second subtoken rented to the second account to the third account; and
an instruction to update the first rental data for the token indicating a wallet address of the first account to indicate a wallet address of the third account.

10. The method of claim 1, wherein the smart contract further includes:
an instruction to receive an issued token number from a management terminal corresponding to a management account and to transmit as many first subtokens and second subtokens as the issued token number to the management account.

11. The method of claim 1, wherein the smart contract further includes:
an instruction to receive a wallet address of the first account that purchases the token and a purchasing token quantity of the first account from a management terminal corresponding to a management account and to transmit as many first subtokens and second subtokens as the purchasing token quantity to the first account.

12. The method of claim 1, wherein the smart contract further includes an instruction to provide a basic reward for the first subtoken to the first account every first period, and
wherein the instruction to provide the basic reward includes an instruction to transmit as many tokens as a token number determined according to a ratio of a number of tokens owned by the first account to a total number of issued tokens among a number of additionally issued tokens corresponding to a profit in the first period determined based on at least one of a profit from using the real property or a profit margin from selling the real property.

13. The method of claim 1, wherein the smart contract further includes an instruction to provide an additional reward for the first subtoken to the first account every second period, and
wherein the instruction to provide the additional reward includes an instruction to determine a number of additionally issued tokens corresponding to the second period, based on total real property value contribution degree data generated based on pieces of real property value contribution degree data of a plurality of accounts owning the tokens.

14. The method of claim 13, wherein the instruction to provide the additional reward includes:
an instruction to determine the number of additionally issued tokens, based on a contribution degree excess when a total real property value contribution degree included in the total real property value contribution degree data exceeds a threshold contribution degree.

15. The method of claim 13, wherein the instruction to provide the additional reward includes:
an instruction to update real property value contribution degree data of the first account by adding a contribution degree included in real property value contribution degree data of the second account to a contribution degree included in the real property value contribution degree data of the first account.

16. The method of claim 15, wherein the instruction to provide the additional reward includes:
an instruction to calculate a real property value contribution ratio of the first account, based on the updated real property value contribution degree data of the first account and the total real property value contribution degree data; and
an instruction to transmit a predetermined number of tokens among the number of additionally issued tokens to the first account, based on the calculated real property value contribution ratio of the first account.

17. The method of claim 1, wherein the smart contract further includes:
an instruction to initialize real property value contribution degree data of each of a plurality of accounts owning the token after completing an operation of providing an additional reward to the first account.

18. An electronic apparatus comprising:
a communication interface configured to communicate with a network;
a processor configured to execute a computer program including one or more instructions; and
a memory configured to load the computer program,
wherein the computer program includes:
an instruction to transmit a first subtoken and a second subtoken corresponding to a token to a first account;
an instruction to provide a first reward for the second subtoken to the first account;
an instruction to transmit the second subtoken to a second account in response to receiving rental data for the token between the first account and the second account; and
an instruction to provide the first reward to the second account when the second subtoken has been transmitted to the second account.

19. A terminal connected to a computer network including a blockchain network, the terminal comprising:
a processor configured to:
transmit a number of issued tokens determined based on a user input to an address of a smart contract;
receive a wallet address of a first account and a purchasing token quantity from a first terminal corresponding to the first account that is a token purchaser; and
transmit the wallet address of the first account and the purchasing token quantity to the address of the smart contract.

20. A terminal connected to a computer network including a blockchain network, the terminal comprising:
a processor configured to:
receive a user input for a purchasing token quantity and transmit the purchasing token quantity and a wallet address of a first account to a management terminal corresponding to a management account;
receive a user input to confirm a contribution degree and receive real property value contribution degree data of the first account from the blockchain network;
receive a user input to modify a contribution degree and transmit a request to modify the real property value contribution degree data of the first account to the blockchain network;
receive a user input to confirm a reward and request data related to a basic reward and an additional reward scheduled to be provided to the first account from the blockchain network;
receive a user input to confirm a reward and output a first reward provided to the first account on a screen; and
receive a user input to confirm a rental and output rental data for the token on the screen.

21. A terminal connected to a computer network including a blockchain network, the terminal comprising:
a processor configured to:
transmit a wallet address of a second account to a first terminal of a first account that owns a token;
receive a user input to confirm a contribution degree and request real property value contribution degree data of the second account from the block chain network; and
receive a user input to confirm a reward and output a first reward provided to the second account on a screen.

22. A method of providing a reward to an owner of a token corresponding to a share of real property by a processor connected to a computer network including a blockchain network, the method comprising:
providing a reward to a first account that owns the token, based on real property value contribution degree data of the first account;
providing an occupation reward to the first account that occupies the token;
transmitting the token to the second account in response to receiving rental data for the token between the first account and the second account;
providing a reward to the first account, based on real property value contribution degree data of the second account that receives the token; and
providing the occupation reward to the second account that occupies the token.
